(19) United States
(12) Patent Application Publication
(10) Pub. No.: US 2026/0251841 A1
(43) Pub. Date: Aug. 27, 2026

(54) ANTI-RESONANT HOLLOW CORE OPTICAL FIBER WITH CONTACTING CLADDING ELEMENTS WITH MULTIPLY NESTED CAPILLARIES

(71) Applicant: CORNING INCORPORATED, CORNING, NY (US)

(72) Inventor: Ming-Jun Li, Horseheads, NY (US)

(21) Appl. No.: 19/541,991

(22) Filed: Feb. 17, 2026

Related U.S. Application Data
(60) Provisional application No. 63/763,990, filed on Feb. 27, 2025.

(51) Int. Cl. G02B 6/02; C03B 23/07; G02B 6/036

(52) U.S. Cl. CPC G02B 6/02; C03B 23/076; G02B 6/03605; G02B 6/0365; C03B 2203/16; C03B 2203/22

(57) ABSTRACT

An anti-resonant hollow core optical fiber including: a cladding tube including a cladding inner surface at a cladding inner radius from a fiber longitudinal axis, the cladding inner radius varying azimuthally around the fiber longitudinal axis, the cladding inner surface defining recesses; a plurality of primary capillaries, each disposed within a different one of the recesses and contacting the cladding inner surface and an adjacent primary capillary in both azimuthal directions around the fiber longitudinal axis; a plurality of first nested capillaries each disposed within a different one of the primary capillaries; a plurality of second nested capillaries each disposed within the interior of a different one of the plurality of first nested capillaries; and an effective core region tangential to the plurality of primary capillaries at a core radius from the fiber longitudinal axis, the plurality of primary capillaries disposed radially outward of the effective core region.

This Application claims the benefit of priority to U.S. Provisional Patent Application Ser. No. 63/763,990 filed on Feb. 27, 2025, the content of which is relied upon and incorporated herein by reference in its entirety.

### TECHNICAL FIELD

The present disclosure pertains to anti-resonant hollow core optical fibers and, more particularly, to anti-resonant hollow core optical fibers that include anti-resonant cladding elements that (i) contact each other, (ii) are set within recesses of a cladding tube, and (iii) contain multiply nested capillaries.

### BACKGROUND

Optical fibers are utilized to transmit data. More particularly, a transmitter converts information into pulses of electromagnetic radiation and transmits the pulses into the optical fiber. The electromagnetic radiation transmits along the optical fiber to a receiver. The receiver re-converts the pulses of electromagnetic radiation back into information.

Optical fiber often includes a solid core through which the electromagnetic radiation moves and a cladding surrounding the solid core to maintain the electromagnetic radiation within the solid core. The cladding and the solid core exhibit different indices of refraction, and the difference causes the electromagnetic radiation to stay generally within the solid core during transmission due to total internal reflection. The solid core of the optical fiber is often formed of silica-based glass.

Transmission performance of optical fibers with a solid core can suffer from confinement loss and losses due to scattering, absorption, and bending. Imperfection in the material of the solid core can cause scattering and absorption of the electromagnetic radiation pulses that the optical fiber is transmitting. Further losses of the intensity of the electromagnetic radiation from the core into the cladding occur due to external perturbations, such as bending and stresses when optical fibers are packed and deployed in cables. Confinement losses result from leaky modes in the optical fiber. Leaky modes have evanescent fields of optical signal intensity that extend beyond the core into the cladding. Losses due to scattering, absorption, and lack of confinement reduce the power of the electromagnetic radiation pulses. Reduced power limits the ability of the receiver to convert the pulses back into information, which limits the reach of the optical fiber.

In an effort to improve the performance of optical fibers, hollow core optical fibers are under development. Hollow core optical fibers mitigate attenuation of optical signals and provide further advantages such as low non-linearity, low dispersion, and low latency. Hollow core optical fibers, as the name suggests, do not include a core of solid material. Rather, the core is a gas, such as air. Due to the absence of a solid core, it is thought that the electromagnetic radiation could transmit without as much scattering and absorption loss.

There is still the issue of confinement of the electromagnetic radiation within the core. A category of hollow core optical fibers relies upon anti-resonance between the core and the cladding to confine the electromagnetic radiation within the core and to prevent leakage of modes into the cladding. Those optical fibers are sometimes referred to as anti-resonant hollow core optical fibers, or AR-HCFs for short. With AR-HCFs, a central hollow core is surrounded by anti-resonant cladding elements contained in a cladding tube. The anti-resonant cladding elements can be made of relatively thin glass to realize an anti-resonant effect. Anti-resonance may occur when electromagnetic radiation within any of the anti-resonant cladding elements destructively interferes with itself, resulting in minimum transmission of optical power through the glass of the anti-resonant cladding element. Anti-resonance may also occur when coupling efficiency of core modes to cladding modes is zero or weak. The greater the anti-resonant effect of the cladding elements, the greater the confinement of electromagnetic radiation within the core, and thus the lower the confinement loss.

Engineering and design of anti-resonant cladding elements to achieve better confinement loss across desirable wavelength ranges is an evolving field of endeavor. In addition, there is a practical problem in that AR-HCFs are difficult to manufacture at large scale. The anti-resonant cladding elements must satisfy exacting structural requirements to perform efficiently and are highly sensitive to dimensional fluctuations expected from manufacturing variability. For example, if anti-resonant cladding elements designed not to contact each other but do contact each other as a result of manufacturing imprecision, the anti-resonant hollow core optical fiber exhibits peaks in confinement loss as a function of wavelength. Further, inaccuracies in the azimuthal position of the anti-resonant cladding elements relative to each other impacts the confinement loss. Furthermore, it is difficult to manufacture the anti-resonant hollow core optical fiber where the anti-resonant cladding elements do not make contact and/or where the anti-resonant cladding elements are drawn in their as-designed azimuthal position. There is accordingly a need for new designs of hollow core optical fibers that provide greater stability in the dimensions and position of anti-resonant cladding elements.

### SUMMARY

The present disclosure addresses those problems, and others, with an anti-resonant hollow core optical fiber that includes a cladding tube with recesses within which anti-resonant cladding elements with primary capillaries are disposed and dimensioned so that adjacent primary capillaries contact each other. The anti-resonant hollow core optical fiber is designed to avoid sharp attenuation peaks in the attenuation spectrum despite contact of the primary capillaries. The anti-resonant hollow core optical fiber becomes easier to manufacture because contact between adjacent primary capillaries stabilizes the structure and makes it less sensitive to variabilities in manufacturing. The recesses further stabilize the structure by preventing the primary capillaries from rotating or moving azimuthally relative to each other and the cladding tube during manufacture. The cladding tube, having an inner surface with recesses forming peaks extending toward a center of the cladding tube, fills in the space radially outward of the primary capillaries. The recesses are depressions that increase the distance of the inner surface of the cladding tube and the primary capillaries from the hollow core to mitigate leakage of the fundamental mode through the primary capillaries to the cladding tube thereby improving confinement of the fundamental mode.

Confinement is further improved by including nested capillaries within the primary capillaries. Each primary capillary contains at least two nested capillaries. The at least two nested capillaries are configured such that one of the at least two nested capillaries is nested within another of the at least two nested capillaries to form an anti-resonant cladding element that includes a multiply nested capillary. Embodiments in which the primary capillary contains three or more nested capillaries to form triply nested, quadruply nested etc. capillaries are also envisioned.

Not only is manufacturing of the hollow core optical fiber easier with the designs described herein but performance is improved as the fundamental mode exhibits low confinement loss and a smooth attenuation spectrum. At the same time, confinement loss for higher order modes is relatively high, which is beneficial for achieving or approaching single mode transmission in a hollow core optical fiber.

According to a first aspect of the present disclosure, an anti-resonant hollow core optical fiber comprises: (1) a fiber longitudinal axis extending from a first fiber end to a second fiber end; (2) a cladding tube extending from the first fiber end to the second fiber end azimuthally around the fiber longitudinal axis, the cladding tube comprising (a) a cladding outer surface at a cladding outer radius from the fiber longitudinal axis and (b) a cladding inner surface at a cladding inner radius from the fiber longitudinal axis, wherein the cladding inner radius is azimuthally variable around the fiber longitudinal axis and the cladding inner surface defines a plurality of recesses; (3) a plurality of primary capillaries arranged azimuthally around the fiber longitudinal axis, each of the plurality of primary capillaries (a) disposed within a different one of the plurality of recesses and contacting the cladding inner surface, (b) contacting or merging with an adjacent primary capillary in both azimuthal directions around the fiber longitudinal axis, and (c) comprising (i) a primary longitudinal axis that is parallel to the fiber longitudinal axis, (ii) a primary outer surface at a primary outer radius from the primary longitudinal axis, and (iii) a primary inner surface at a primary inner radius from the primary longitudinal axis, the primary inner surface defining a primary interior; (4) a plurality of first nested capillaries extending longitudinally from the first fiber end to the second fiber end, each of the plurality of first nested capillaries (a) disposed within the primary interior of a different one of the plurality of primary capillaries and (b) comprising (i) a first capillary axis that is parallel to the fiber longitudinal axis and (ii) a first nested interior; (5) a plurality of second nested capillaries extending longitudinally from the first fiber end to the second fiber end, each of the plurality of second nested capillaries (a) disposed within the first nested interior of a different one of the plurality of first nested capillaries and (b) comprising (i) a second capillary axis that is parallel to the fiber longitudinal axis and (ii) a second nested interior; and (6) an effective core region tangential to the plurality of primary capillaries at a core radius from the fiber longitudinal axis, the plurality of primary capillaries disposed radially outward of the effective core region.

According to a second aspect of the present disclosure, the anti-resonant hollow core optical fiber of the first aspect is presented, wherein each of the plurality of recesses merges with an adjacent recess in both azimuthal directions around the fiber longitudinal axis so that the cladding inner surface forms peaks pointing inward toward the fiber longitudinal axis.

According to a third aspect of the present disclosure, the anti-resonant hollow core optical fiber of the first aspect is presented, wherein the cladding inner surface further defines plateau portions where the cladding inner radius is constant azimuthally around the fiber longitudinal axis, and each of the plurality of recesses are separated from an adjacent recess in both azimuthal directions around the fiber longitudinal axis by a different one of the plateau portions.

According to a fourth aspect of the present disclosure, the anti-resonant hollow core optical fiber of any one of the first through third aspects is presented, wherein the primary outer radius of each of the plurality of primary capillaries is within a range of from 20 μm to 90 μm.

According to a fifth aspect of the present disclosure, the anti-resonant hollow core optical fiber of any one of the first through fourth aspects is presented, wherein each of the plurality of primary capillaries further comprises a primary thickness that is within a range of from 250 nm to 1500 nm.

According to a sixth aspect of the present disclosure, the anti-resonant hollow core optical fiber of any one of the first through fifth aspects is presented, wherein each of the plurality of primary capillaries further comprises a primary thickness that is within +30% of a calculated thickness t as defined by the equation:

$$t = \frac{( 2 m - 1 ) λ}{4 \sqrt{{n}^{2} - 1}}$$

where, t is the calculated thickness, m is an integer (e.g., 1, 2, 3, . . . ) corresponding to the order of antiresonance, λ is the operating wavelength, and n is the refractive index of the primary capillaries.

According to a seventh aspect of the present disclosure, the anti-resonant hollow core optical fiber of any one of the first through sixth aspects is presented, wherein (i) the cladding tube has from 3 to 9 recesses, (ii) the anti-resonant hollow core optical fiber has from 3 to 9 primary capillaries, and (iii) the quantity of recesses and the quantity of primary capillaries are the same.

According to an eighth aspect of the present disclosure, the anti-resonant hollow core optical fiber of any one of the first through seventh aspects is presented, wherein the core radius is within a range of from 5 μm to 100 μm.

According to a ninth aspect of the present disclosure, the anti-resonant hollow core optical fiber of any one of the first through eighth aspects further comprises: a capillary region radius that is tangential to the primary outer surface of each of the plurality of primary capillaries but radially outward of the core radius; and a primary capillary region between the capillary region radius and the core radius, each of the plurality of primary capillaries disposed entirely within the primary capillary region.

According to a tenth aspect of the present disclosure, the anti-resonant hollow core optical fiber of the ninth aspect is presented, wherein the cladding tube occupies an entirety of a volume, outside of the plurality of primary capillaries, that is radially inward of the capillary region radius and radially outward of where adjacent primary capillaries contact or merge.

According to an eleventh aspect of the present disclosure, the anti-resonant hollow core optical fiber of the ninth aspect is presented, wherein (i) bury radial lines extend from the longitudinal axis radially outward through the cladding tube, each of the bury radial lines extending through where different pairs of adjacent primary capillaries contact or merge, and (ii) the cladding tube occupies a portion of a volume, outside of the plurality of primary capillaries that is radially inward of the capillary region radius to a depth from the capillary region radius along each of the bury radial longs toward where the adjacent primary capillaries contact or merge.

According to a twelfth aspect of the present disclosure, the anti-resonant hollow core optical fiber of the eleventh aspect is presented, wherein the depth is from 10% to 85% of a radial distance from the capillary region radius to where the adjacent primary capillaries contact or merge.

According to a thirteenth aspect of the present disclosure, the anti-resonant hollow core optical fiber of any one of the first through twelfth aspects, wherein each of the plurality of first nested capillaries further comprises a first nested outer radius from the first capillary axis that is within a range of from 15 μm to 89 μm.

According to a fourteenth aspect of the present disclosure, the anti-resonant hollow core optical fiber of any one of the first through thirteenth aspects is presented, wherein the difference between the primary capillary radius and the first nested capillary radius is less than 5 μm

According to a fifteenth aspect of the present disclosure, the anti-resonant hollow core optical fiber of any one of the first through fourteenth aspects is presented, wherein each of the plurality of first nested capillaries further comprises a first nested thickness that is within a range of from 250 nm to 1500 nm.

According to a sixteenth aspect of the present disclosure, the anti-resonant hollow core optical fiber of any one of the first through fifteenth aspects is presented, wherein each of the plurality of first nested capillaries further comprises a first nested thickness that is within +30% of a calculated thickness defined by the equation:

$$t = \frac{( 2 m - 1 ) λ}{4 \sqrt{{n}^{2} - 1}}$$

where, t is the calculated thickness, m is an integer (e.g., 1, 2, 3, . . . ) corresponding to the order of antiresonance, λ is the operating wavelength, and n is the refractive index of the first nested capillaries.

According to a seventeenth aspect of the present disclosure, the anti-resonant hollow core optical fiber of any of the first through sixteenth aspect is presented, wherein each of the plurality of second nested capillaries further comprises a second nested outer radius from the second capillary axis that is within a range of from 10 μm to 85 μm.

According to an eighteenth aspect of the present disclosure, the anti-resonant hollow core optical fiber of any one of the first through seventeenth aspects is presented, wherein each of the plurality of second nested capillaries further comprises a second nested thickness that is within a range of from 250 nm to 1500 nm.

According to a nineteenth aspect of the present disclosure, the anti-resonant hollow core optical fiber of any one of the first through eighteenth aspects is presented, wherein each of the plurality of second nested capillaries further comprises a second nested thickness that is within +30% of a calculated thickness defined by the equation:

$$t = \frac{( 2 m - 1 ) λ}{4 \sqrt{{n}^{2} - 1}}$$

where, t is the calculated thickness, m is an integer (e.g., 1, 2, 3, . . . ) corresponding to the order of antiresonance, λ is the operating wavelength, and n is the refractive index of the second nested capillaries.

According to a twentieth aspect of the present disclosure, the anti-resonant hollow core optical fiber of any one of the first through nineteenth aspects further comprises: a plurality of third nested capillaries extending longitudinally from the first fiber end to the second fiber end, each of the plurality of third nested capillaries (a) disposed within the second nested interior of a different one of the plurality of second nested capillaries and (b) comprising (i) a third capillary axis that is parallel to the fiber longitudinal axis and (ii) a third nested interior.

According to a twenty-first aspect of the present disclosure, the anti-resonant hollow core optical fiber of the twentieth aspect is presented, wherein each of the plurality of third nested capillaries further comprises a third nested outer radius from the third capillary axis that is within a range of from 10 μm to 80 μm.

According to a twenty-second aspect of the present disclosure, the anti-resonant hollow core optical fiber of any one of the twentieth through twenty-first aspects is presented, wherein each of the plurality of third nested capillaries further comprises a second nested thickness that is within a range of from 250 nm to 1500 nm.

According to a twenty-third aspect of the present disclosure, the anti-resonant hollow core optical fiber of any one of the twentieth through twenty-second aspects is presented, wherein each of the plurality of third nested capillaries further comprises a second nested thickness that is within +30% of a calculated thickness defined by the equation:

$$t = \frac{( 2 m - 1 ) λ}{4 \sqrt{{n}^{2} - 1}}$$

where, t is the calculated thickness, m is an integer (e.g., 1, 2, 3, . . . ) corresponding to the order of antiresonance, λ is the operating wavelength, and n is the refractive index of the second nested capillaries.

According to a twenty-fourth aspect of the present disclosure, the anti-resonant hollow core optical fiber of any one of the first through twenty-third aspects is presented, wherein the primary capillary contacts the cladding inner surface at a contact point and the first nested capillary contacts the primary inner surface at a point along a radial line extending from the fiber longitudinal axis to the contact point

According to a twenty-fifth aspect of the present disclosure, the anti-resonant hollow core optical fiber of the twenty-fourth aspect is presented, wherein the second nested capillary contacts an inner surface of the first nested capillary at a point along the radial line extending from the fiber longitudinal axis to the contact point.

According to a twenty-sixth aspect of the present disclosure, the anti-resonant hollow core optical fiber of any one of the first through twenty-fifth aspects is presented, wherein the plurality of primary capillaries includes three or more of the primary capillaries, each of the three or more primary capillaries including one of the first nested capillaries and one of the second nested capillaries

According to a twenty-seventh aspect of the present disclosure, the anti-resonant hollow core optical fiber of the twenty-sixth aspect is presented, wherein each of the three or more primary capillaries further includes a third nested capillary disposed within each of the second nested capillaries.

According to a twenty-eighth aspect of the present disclosure, the anti-resonant hollow core optical fiber of the twenty-seventh aspect is presented, wherein each of the three or more primary capillaries further includes a fourth nested capillary disposed within each of the third nested capillaries.

According to a twenty-ninth aspect of the present disclosure, the anti-resonant hollow core optical fiber of any one of the first through twenty-eighth aspects is presented, wherein the anti-resonant hollow core optical fiber exhibits a confinement loss for the fundamental mode of electromagnetic radiation at each wavelength in a wavelength range from 1300 nm to 1600 nm that is less than or equal to 0.50 dB/km.

According to a thirtieth aspect of the present disclosure, the anti-resonant hollow core optical fiber of any one of the first through twenty-eighth aspects is presented, wherein the anti-resonant hollow core optical fiber exhibits a confinement loss for the fundamental mode of electromagnetic radiation at each wavelength in a wavelength range from 1300 nm to 1600 nm that is less than or equal to 0.20 dB/km.

According to a thirty-first aspect of the present disclosure, the anti-resonant hollow core optical fiber of any one of the first through twenty-eighth aspects is presented, wherein the anti-resonant hollow core optical fiber exhibits a confinement loss for the fundamental mode of electromagnetic radiation at each wavelength in a wavelength range from 1300 nm to 1600 nm that is less than or equal to 0.10 dB/km.

According to a thirty-second aspect of the present disclosure, the anti-resonant hollow core optical fiber of any one of the first through thirty-first aspects is presented, wherein the anti-resonant hollow core optical fiber exhibits a confinement loss for higher order modes of electromagnetic radiation at each wavelength in a wavelength range from 1300 nm to 1600 nm that is greater than or equal to 0.50 dB/km.

According to a thirty-third aspect of the present disclosure, the anti-resonant hollow core optical fiber of any one of the first through thirty-first aspects is presented, wherein the anti-resonant hollow core optical fiber exhibits a confinement loss for higher order modes of electromagnetic radiation at each wavelength in a wavelength range from 1300 nm to 1600 nm that is greater than or equal to 10 dB/km.

According to a thirty-fourth aspect of the present disclosure, the anti-resonant hollow core optical fiber of any one of the first through thirty-first aspects is presented, wherein the anti-resonant hollow core optical fiber exhibits a confinement loss for higher order modes of electromagnetic radiation at each wavelength in a wavelength range from 1300 nm to 1600 nm that is greater than or equal to 100 dB/km.

According to a thirty-fifth aspect of the present disclosure, a method of manufacturing an anti-resonant hollow core optical fiber comprises: (a) a preform recess formation step comprising forming a plurality of preform recesses into a cladding preform inner surface of a cladding preform tube through which a cladding preform longitudinal axis extends, each of the plurality of preform recesses disposed longitudinally from a first preform end to a second preform end of the cladding preform tube; (b) a primary preform capillary arrangement step comprising arranging a plurality of primary preform capillaries within the plurality of preform recesses of the cladding preform tube, each of the plurality of primary preform capillaries (i) comprising an outer primary preform surface at an outer primary preform radius from a primary capillary preform axis parallel to the cladding preform longitudinal axis, (ii) contacting an adjacent primary preform capillary in both azimuthal directions around the cladding preform longitudinal axis, and (iii) contacting the cladding preform inner surface, wherein, the plurality of preform recesses is dimensioned to substantially match the outer primary preform radius of the plurality of primary preform capillaries; (c) a first nested preform capillary arrangement step comprising arranging a plurality of first nested preform capillaries in the plurality of primary preform capillaries, each of the plurality of primary preform capillaries including one of the plurality of first nested preform capillaries; and (d) a second nested preform capillary arrangement step comprising arranging a plurality of second nested preform capillaries in the plurality of first nested preform capillaries, each of the plurality of first nested preform capillaries including one of the plurality of second nested preform capillaries.

According to a thirty-sixth aspect of the present disclosure, the anti-resonant hollow core optical fiber of the thirty-fifth aspect is presented, wherein a third nested preform capillary arrangement step comprising arranging a plurality of third nested preform capillaries in the plurality of second nested preform capillaries, each of the plurality of second nested preform capillaries including one of the plurality of third nested preform capillaries.

According to a thirty-seventh aspect of the present disclosure, the anti-resonant hollow core optical fiber of the thirty-sixth aspect is presented, wherein each of the plurality of preform recesses merge with an adjacent preform recess in both azimuthal directions around the preform longitudinal axis so that the cladding preform inner surface forms peaks pointing inward toward the cladding preform longitudinal axis.

According to a thirty-eighth aspect of the present disclosure, the anti-resonant hollow core optical fiber of the thirty-sixth aspect is presented, wherein the cladding preform inner surface forms plateaus of constant radius from the cladding preform longitudinal axis between adjacent preform recesses in both azimuthal directions around the preform longitudinal axis.

According to a thirty-ninth aspect of the present disclosure, the anti-resonant hollow core optical fiber of any one of the thirty-fifth through thirty-eighth aspects is presented, wherein a drawing step comprising drawing an anti-resonant hollow core optical fiber from the preform.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

In the Drawings:

FIG. 1 is a perspective view of an anti-resonant hollow core optical fiber of the present disclosure, illustrating a cladding tube and anti-resonant cladding elements with primary capillaries that contact and contain nested capillaries disposed within the cladding tube;

FIG. 2A is a cross-sectional view of the anti-resonant hollow core optical fiber taken through line II-II of FIG. 1, illustrating the cladding tube (but not the anti-resonant cladding elements) having a plurality of recesses into a cladding inner surface and forming peaks pointing toward a fiber longitudinal axis;

FIG. 2B is a cross-sectional view of an alternative embodiment of anti-resonant hollow core optical fiber, illustrating a cladding tube (but not anti-resonant cladding elements) having a plurality of recesses into a cladding inner surface and forming plateaus facing toward a fiber longitudinal axis;

FIG. 2C is a cross-sectional view of the primary capillary and nested capillaries of the anti-resonant cladding elements of the anti-resonant hollow core optical fiber of FIG. 1;

FIG. 2D is a cross-sectional view of the primary capillary and nested capillaries of an embodiment of an anti-resonant cladding element with a triply nested capillary;

FIG. 2E shows selected variations of the anti-resonant cladding element of FIG. 2C;

FIG. 2F shows selected variations of the anti-resonant cladding element of FIG. 2D;

FIG. 3A is a cross-sectional view of the anti-resonant hollow core optical fiber taken through line IIIA-IIIA of FIG. 1, illustrating (a) the anti-resonant cladding elements and (b) adjacent recesses forming peaks pointing toward the fiber longitudinal axis;

FIG. 3B is a cross-sectional view of the anti-resonant hollow core optical fiber taken through line IIIB-IIIB of FIG. 1, illustrating the cladding inner surface forming the plurality of recesses and plateaus between adjacent recesses so that the recesses and plateaus alternate azimuthally around the fiber longitudinal axis;

FIG. 4 is a graph illustrating the variation in core diameter as a function of the diameter of primary capillaries for sets of primary capillaries that differ in number.

FIG. 5 is a schematic diagram of a method of making the anti-resonant hollow core optical fiber, setting forth a preform recess formation step, a primary preform capillary arrangement step, and a drawing step;

FIG. 6 is a schematic diagram of the preform recess formation step, illustrating a plurality of recesses having been formed into a cladding preform inner surface of a cladding preform tube;

FIG. 7 is a schematic diagram of the primary preform capillary arrangement step, illustrating a plurality of primary preform capillaries having been coupled to the cladding preform inner surface within the plurality of recesses, with adjacent primary preform capillaries contacting each other;

FIG. 8 is a cross-sectional view taken along line VII-VII of FIG. 7, illustrating outer primary preform surfaces of adjacent primary preform capillaries contacting;

FIG. 9 is a schematic diagram of the drawing step, illustrating the anti-resonant hollow core optical fiber being drawn from the optical fiber preform;

FIG. 10 is a cross-sectional view of an exemplary anti-resonant hollow core optical fiber.

FIG. 11 is a graph plotting confinement loss for both (i) the fundamental mode and (ii) higher order modes as a function of wavelength of electromagnetic radiation for an embodiment of an anti-resonant hollow core optical fiber;

FIG. 12 is a graph plotting confinement loss for both (i) the fundamental mode and (ii) higher order modes as a function of wavelength of electromagnetic radiation for an embodiment of an anti-resonant hollow core optical fiber;

FIG. 13 is a graph plotting confinement loss for both (i) the fundamental mode and (ii) higher order modes as a function of wavelength of electromagnetic radiation for an embodiment of an anti-resonant hollow core optical fiber;

FIG. 14 depicts an embodiment of an antiresonant cladding element having a primary capillary and five nested capillaries.

FIG. 15 is a graph plotting confinement loss for both (i) the fundamental mode and (ii) higher order modes as a function of wavelength of electromagnetic radiation for an embodiment of an anti-resonant hollow core optical fiber; and

FIG. 16 is a graph plotting confinement loss for the fundamental mode as a function of wavelength of electromagnetic radiation for an embodiment of the anti-resonant hollow core optical fiber.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

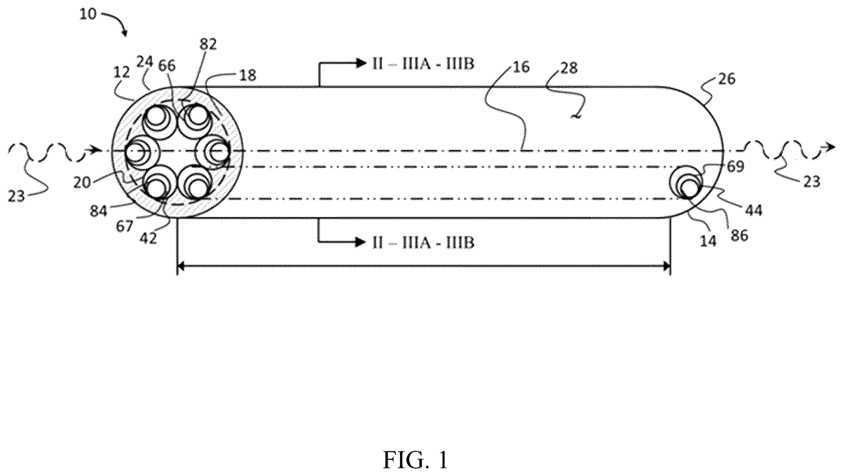

Referring to FIGS. 1-3B, an anti-resonant hollow core optical fiber 10 includes a first fiber end 12, a second fiber end 14, a fiber longitudinal axis 16, a cladding tube 18, a plurality of primary capillaries 20, and an effective core region 22. The fiber longitudinal axis 16 extends from the first fiber end 12 to the second fiber end 14. In use, electromagnetic radiation 23 enters into the first fiber end 12, transmits predominantly within the effective core region 22, and exits the second fiber end 14.

The cladding tube 18 likewise extends, azimuthally around the fiber longitudinal axis 16, from the first fiber end 12 to the second fiber end 14. The cladding tube 18 includes a first cladding end 24 and a second cladding end 26. The first cladding end 24 is proximate, and may at least partially define, the first fiber end 12. The second cladding end 26 is proximate, and may at least partially define, the second fiber end 14.

The cladding tube 18 further includes a cladding outer surface 28 and a cladding inner surface 30. The cladding outer surface 28 is at a cladding outer radius 32 from the fiber longitudinal axis 16. The cladding inner surface 30 is at a cladding inner radius 34 from the fiber longitudinal axis 16. The cladding inner surface 30 defines a cladding interior 36. The cladding inner radius 34 varies as a function of azimuthal position around the fiber longitudinal axis 16. The cladding inner surface 30 defines a plurality of recesses 38.

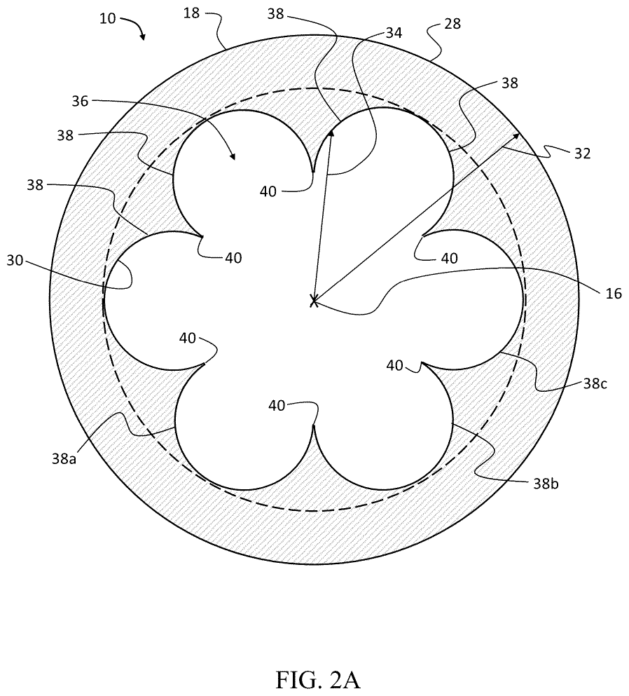

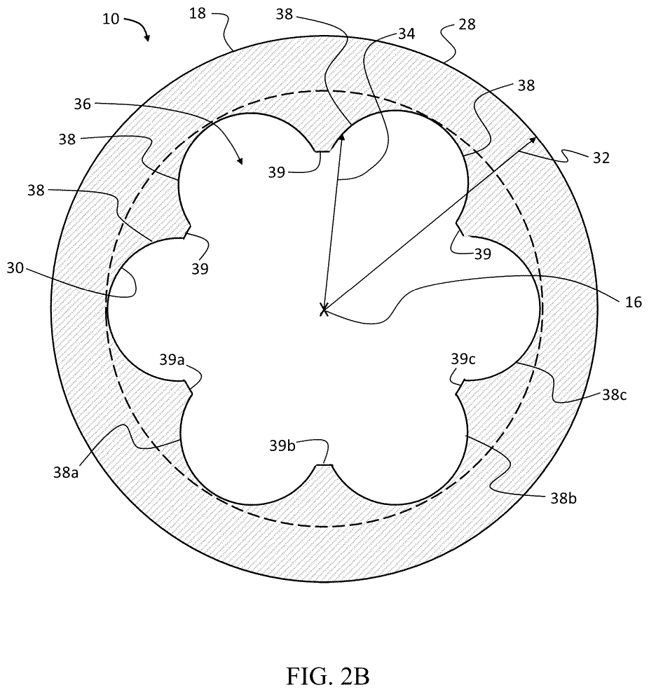

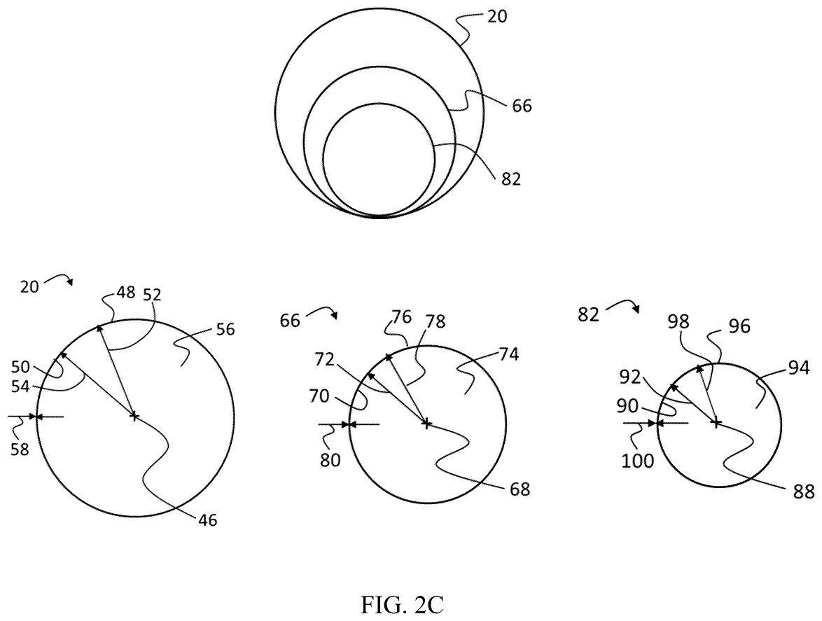

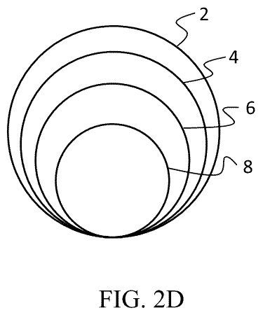

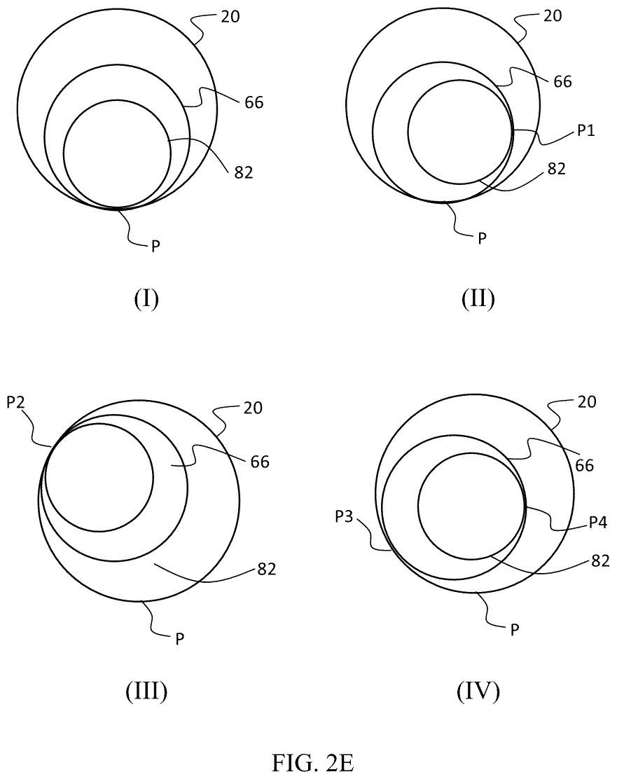

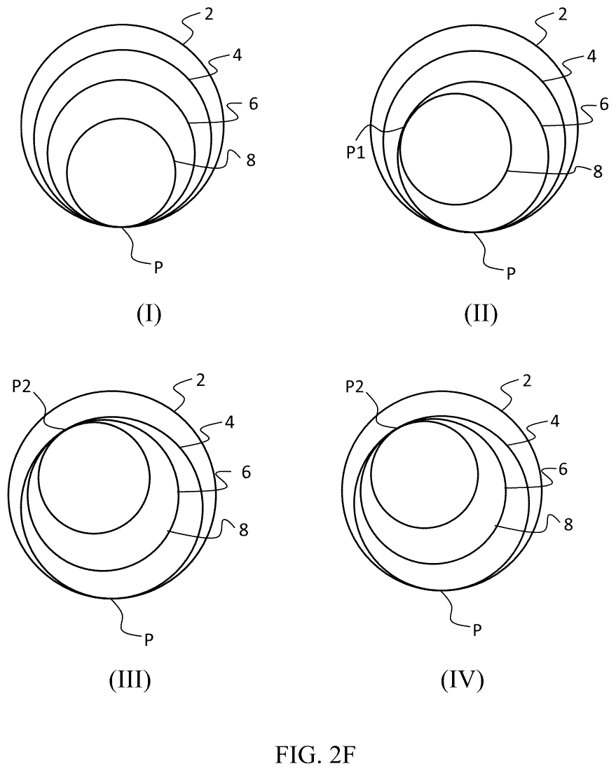

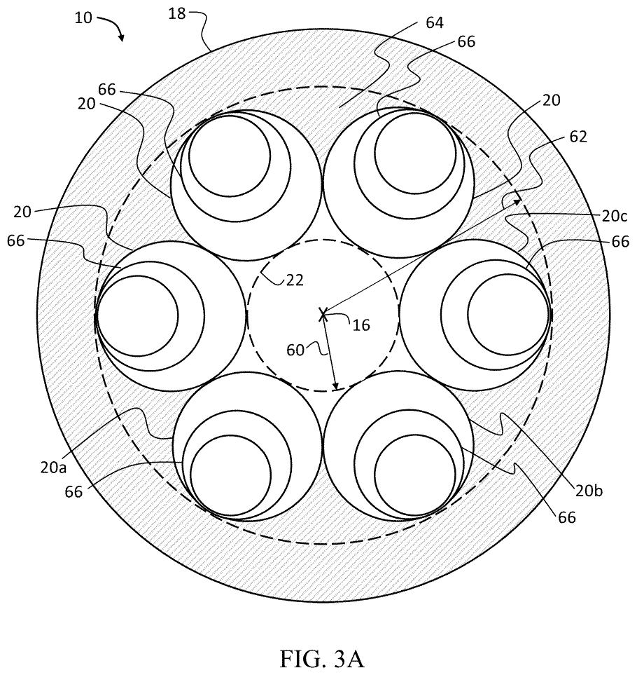

In embodiments (see FIGS. 2A and 3A), each of the plurality of recesses 38 merges with an adjacent recess 38 in both azimuthal directions around the fiber longitudinal axis 16. For example, the recess 38b merges with the recess 38c in one azimuthal direction around the fiber longitudinal axis 16 and additionally with the recess 38a in the other azimuthal direction. The bi-directional merging of the plurality of recesses 38 thus forms peaks 40. The peaks 40 point inward toward the fiber longitudinal axis 16. The peaks 40 are disposed azimuthally around the fiber longitudinal axis 16.

In other embodiments (FIGS. 2B and 3B), the cladding inner surface 30 presents both the plurality of recesses 38 where the cladding inner radius 34 varies azimuthally around the fiber longitudinal axis 16 and plateaus 39 where the cladding inner radius 34 is constant azimuthally around the fiber longitudinal axis 16. The cladding inner surface 30 alternates between the recesses 38 and the plateaus 39 azimuthally around the fiber longitudinal axis 16. Each one of the plateaus 39 are disposed between different pairs of adjacent recesses 38. Each of the plurality of recesses 38 are separated from the adjacent recess 38 in both azimuthal directions around the fiber longitudinal axis 16 by a different one of the plateaus 39.

The plurality of primary capillaries 20 is disposed within the cladding interior 36. The plurality of primary capillaries 20 is arranged azimuthally around the fiber longitudinal axis 16. Each of the plurality of primary capillaries 20 includes a capillary first end 42 and a capillary second end 44. The capillary first end 42 is proximate, and may at least partially define, the first fiber end 12. The capillary second end 44 is proximate, and may at least partially define, the second fiber end 14.

Each of the plurality of primary capillaries 20 further includes a primary longitudinal axis 46 that is parallel to the fiber longitudinal axis 16 (FIG. 2C). In addition, each of the plurality of primary capillaries 20 further includes a primary outer surface 48 and a primary inner surface 50. The primary outer surface 48 is at a primary outer radius 52 from the primary longitudinal axis 46. The primary inner surface 50 is at a primary inner radius 54 from the primary longitudinal axis 46. The difference between the primary outer radius 52 and the primary inner radius 54 is the thickness 58. The primary inner surface 50 defines a primary interior 56. For a given core radius 60 of effective core region 22, the primary outer radius 52 varies with the number of primary capillaries 20 (see below). In embodiments, the primary outer radius 52 is greater than or equal to 15 μm, or greater than or equal to 20 μm, or greater than or equal to 25 μm, or greater than or equal to 30 μm, or greater than or equal to 40 μm, or greater than or equal to 50 μm, or greater than or equal to 60 μm, or greater than or equal to 70 μm, or less than or equal to 90 μm, or less than or equal to 80 μm, or less than or equal to 70 μm, or less than or equal to 60 μm, or less than or equal to 50 μm, or less than or equal to 40 μm, or in the range from 20 μm to 90 μm, or in the range from 20 μm to 80 μm, or in the range from 25 μm to 80 μm, or in the range from 25 μm to 75 μm, or in the range from 30 μm to 70 μm.

Each of the plurality of primary capillaries 20 further includes a primary thickness 58. The primary thickness 58 is the distance measured radially from the primary longitudinal axis 46 between the primary inner surface 50 and the primary outer surface 48. In embodiments, the primary thickness 58 is within a range of from 250 nm to 1500 nm. For example, the primary thickness 58 is 250 nm, 300 nm, 350 nm, 400 nm, 450 nm, 500 nm, 550 nm, 600 nm, 650 nm, 700 nm, 750 nm, 800 nm, 850 nm, 900 nm, 950 nm, 1000 nm, 1050 nm, 1100 nm, 1150 nm, 1200 nm, 1250 nm, 1300 nm, 1350 nm, 1400 nm, 1450 nm, 1500 nm, or within any range bound by any two of those values (e.g., from 350 nm to 700 nm, from 400 nm to 600 nm, from 500 nm to 850 nm, from 700 nm to 1400 nm, from 800 nm to 1300 nm, and so on). In embodiments, the primary thickness 58 is within ±30%, ±25%, ±20%, ±15%, ±10%, or ±5% of a calculated thickness t as defined by the equation:

$$t = \frac{( 2 m - 1 ) λ}{4 \sqrt{{n}^{2} - 1}}$$

where, t is the calculated thickness, m is an integer (e.g., 1, 2, 3, . . . ) corresponding to the order of antiresonance, λ is the operating wavelength, and n is the refractive index of the primary capillaries.

Each of the plurality of primary capillaries 20 is disposed within a different one of the plurality of recesses 38. For example, the primary capillary 20a is disposed within the recess 38a, the primary capillary 20b is disposed within the recess 38b, and the primary capillary 20c is disposed within the recess 38c. Each of the primary capillaries 20 contacts the cladding inner surface 30 and can be fused thereto. Each of the primary capillaries 20 contacts or merges with an adjacent one of the primary capillaries 20 in both azimuthal directions around the fiber longitudinal axis 16. For example, the primary capillary 20b contacts or merges with the primary capillary 20c in one azimuthal direction, and the primary capillary 20b contacts or merges with the primary capillary 20a in the other azimuthal direction.

In embodiments of the anti-resonant hollow optical fiber 10 that include the plateaus 39 of the cladding inner surface 30 (see FIG. 3B), the plurality of primary capillaries 20 and the plateaus 39 alternate azimuthally around the fiber longitudinal axis 16. For example, plateau 39b is disposed between capillary 20a and capillary 20b, and plateau 39c is disposed between capillary 20b and capillary 20c.

The anti-resonant hollow core optical fiber 10 can have any number of primary capillaries 20. In embodiments, the cladding tube 18 has a quantity of recesses 38 that is equal to the number of primary capillaries 20 of the anti-resonant hollow core optical fiber 10. In embodiments, the cladding tube 18 has from 3 to 9 recesses 38. For example, the cladding tube 18 can have 3, 4, 5, 6, 7, 8, or 9 recesses 38. The cladding tube 18 could have less than 3 or greater than 9 recesses 38. The anti-resonant hollow core optical fiber 10 can include from 3 to 9, or from 3 to 6, or from 3 to 5, or from 4 to 8 primary capillaries 20. For example, the anti-resonant hollow core fiber can have 3, 4, 5, 6, 7, 8, or 9 primary capillaries 20. The anti-resonant hollow core optical fiber 10 could also have less than 3 or greater than 9 primary capillaries 20.

The effective core region 22 is within the cladding interior 36. The effective core region 22 is tangential to the primary outer surface 48 of each of the plurality of primary capillaries 20. The effective core region 22 is at a core radius 60 from the fiber longitudinal axis 16. The effective core region 22 extends between the first fiber end 12 and the second fiber end 14. The plurality of primary capillaries 20 is disposed radially outward of the effective core region 22. In embodiments, the core radius 60 is greater than or equal to 5 μm, or greater than or equal to 10 μm, or greater than or equal to 15 μm, or greater than or equal to 20 μm, or greater than or equal to 25 μm, or greater than or equal to 30 μm, or greater than or equal to 35 μm, or greater than or equal to 40 μm, or less than or equal to 70 μm, or less than or equal to 65 μm, or less than or equal to 60 μm, or less than or equal to 55 μm, or less than or equal to 50 μm, or less than or equal to 45 μm, or less than or equal to 40 μm, or in the range from 5 μm to 100 μm, or in the range from 5 μm to 85 μm, or in the range from 5 μm to 70 μm, or in the range from 10 μm to 60 μm, or in the range from 10 μm to 50 μm, or in the range from 10 μm to 40 μm, or in the range from 10 μm to 30 μm.

In embodiments, the anti-resonant hollow core optical fiber 10 further includes a capillary region radius 62 and a primary capillary region 64. The capillary region radius 62 is tangential to the primary outer surface 48 of each of the plurality of primary capillaries 20 but radially outward of the core radius 60. The primary capillary region 64 is disposed between the capillary region radius 62 and the core radius 60. Each of the plurality of primary capillaries 20 is disposed entirely within the primary capillary region 64.

In embodiments (see FIG. 3A), the cladding tube 18 occupies an entirety of the primary capillary region 64, outside of the primary capillaries 20, that is radially inward of the capillary region radius 62 and radially outward of where adjacent primary capillaries 20 contact or merge. Stated another way, in those embodiments, the anti-resonant hollow core optical fiber 10 is substantially free of air gaps within the primary capillary region 64 created by the cladding inner surface 30 and the primary outer surfaces 48 of adjacent primary capillaries 20 radially inward of the cladding inner surface 30. “Substantially free” here means that the anti-resonant hollow core optical fiber 10 is designed to be free of such air gaps but manufacturing imprecision may result in the generation of such air gaps.

In other embodiments (see FIG. 3B), where the plurality of recesses 38 stop short of merging and instead the inner cladding surface 30 forms the plateaus 39, the cladding tube 18 does not occupy an entirety of the primary capillary region 64, outside of the primary capillaries 30, that is radially inward of the capillary region radius 22 and radially outward of where adjacent primary capillaries 20 contact or merge. As a conceptual tool, for these embodiments, bury radial lines 63 extend from the fiber longitudinal axis 16 and radially outward through the cladding tube. Each of the bury radial lines 63 extend through a different one of the plateaus 39 and where a different pairs of the primary capillaries 20 contact or merge. The plateaus 39 reside at a depth 65 from the capillary region radius 62 along each of the bury radial lines 63 toward the fiber longitudinal axis 16. The cladding tube 18 occupies a portion of the volume (e.g., a portion of the primary capillary region 64), outside of the plurality of primary capillaries 20, that is radially inward of the capillary region radius 62 to the depth 65 from the capillary region radius 62 along each of the bury radial lines 63 toward where the adjacent primary capillaries 20 contact or merge. Air pockets 71 occupy the volume between the plateau 39 of the inner cladding surface 30 and where adjacent primary capillaries 20 contact or merge. The air pockets 71 are arranged azimuthally around the fiber longitudinal axis 16. The depth 65 can be from greater than 0% of a radial distance from the capillary region radius 62 to where the adjacent primary capillaries 20 contact or merge to less than 100% of that radial distance. For example, the depth 65 can be 10%, 15%, 20%, 25%, 30%, 35%, 40%, 45%, 50%, 55%, 60%, 65%, 70%, 75%, 85%, or within any range bound by any two of those values of that radial distance (e.g., from 20% to 60%, from 15% to 40%, from 10% to 85%, and so on). Further, the depth 65 can be greater than 0 μm, or greater than 1 μm, or greater than 3 μm, or greater than 5 μm, or greater than 10 μm, or greater than 15 μm, or greater than 20 μm, or greater than 25 μm, or greater than 30 μm, or greater than 35 μm, or greater than 40 μm, or greater than 45 μm, or greater than 50 μm, or greater than 55 μm, or greater than 60 μm, or greater than 65 μm, or in the range from 1 μm to 80 μm, or in the range from 3 μm to 75 μm, or in the range from 5 μm to 70 μm, or in the range from 10 μm to 65 μm, or in the range from 15 μm to 60 μm, or in the range from 20 μm to 55 μm, or in the range from 25 μm to 50 μm, or in the range from 30 μm to 45 μm. In embodiments without plateaus (FIG. 3A), the depth 65 corresponds to 100% of the radial distance from the capillary region radius 62 to where the adjacent primary capillaries 20 contact or merge.

In embodiments, the anti-resonant hollow core optical fiber 10 further includes a plurality of first nested capillaries 66. The plurality of first nested capillaries 66 extends longitudinally within the cladding tube 18 from the first fiber end 12 to the second fiber end 14. Each of the plurality of first nested capillaries 66 includes an end 67 (see FIG. 1) disposed proximate the first cladding end 24 and can at least partially define the first fiber end 12. Each of the first nested capillaries 66 includes another end 69 disposed proximate the second cladding end 26 and can at least partially define the second fiber end 14.

Each of the first nested capillaries 66 is disposed within the primary interior 56 of a different one of the plurality of primary capillaries 20. Each of the first nested capillaries 66 includes a first capillary axis 68 (FIG. 2C). The first capillary axis 68 is parallel to both the fiber longitudinal axis 16 and the primary longitudinal axis 46. Each of the first nested capillaries 66 includes a first nested inner surface 70 at a first nested inner radius 72 from the first capillary axis 68. The first nested inner surface 70 defines a first nested interior 74.

Each of the first nested capillaries 66 further includes a first nested outer surface 76 at a first nested outer radius 78 from the first capillary axis 68. In embodiments, the first nested outer radius 78 is greater than or equal to 10 μm, or greater than or equal to 15 μm, or greater than or equal to 20 μm, or greater than or equal to 25 μm, or greater than or equal to 30 μm, or greater than or equal to 35 μm, or greater than or equal to 40 μm, or greater than or equal to 45 μm, or greater than or equal to 50 μm, or greater than or equal to 60 μm, or greater than or equal to 70 μm, or greater than or equal to 80 μm, or less than or equal to 89 μm, or less than or equal to 80 μm, or less than or equal to 70 μm, or less than or equal to 60 μm, or less than or equal to 55 μm, or less than or equal to 50 μm, or less than or equal to 45 μm, or less than or equal to 40 μm, or in the range from 15 μm to 89 μm, or in the range from 15 μm to 85 μm, or in the range from 20 μm to 60 μm, or in the range from 20 μm to 70 μm, or in the range from 25 μm to 60 μm, or in the range from 25 μm to 50 μm. Preferably, the difference between the primary outer radius 52 and the first nested outer radius 78 is less than 5 μm, more preferably less than 3 μm, and even more preferably less than 1 μm to minimize the leakage loss through contacting region of the primary capillaries.

Each of the first nested capillaries 66 further includes a first nested thickness 80. The first nested thickness 80 is the distance measured radially from the first capillary axis 68 between the first nested inner surface 70 and the first nested outer surface 76 and is equal to the difference between the first nested outer radius 78 and the first nested inner radius 72. In embodiments, the first nested thickness 80 is within a range of from 250 nm to 1500 nm. For example, the first nested thickness 80 is 250 nm, 300 nm, 350 nm, 400 nm, 450 nm, 500 nm, 550 nm, 600 nm, 650 nm, 700 nm, 750 nm, 800 nm, 850 nm, 900 nm, 950 nm, 1000 nm, 1050 nm, 1100 nm, 1150 nm, 1200 nm, 1250 nm, 1300 nm, 1350 nm, 1400 nm, 1450 nm, 1500 nm, or within any range bound by any two of those values (e.g., from 350 nm to 700 nm, from 500 nm to 850 nm, from 700 nm to 1400 nm, from 800 nm to 1300 nm, and so on). In embodiments, the first nested thickness 80 is within ±30%, ±25%, ±20%, ±15%, ±10%, or ±5% of a calculated thickness t as defined by the equation:

$$t = \frac{( 2 m - 1 ) λ}{4 \sqrt{{n}^{2} - 1}}$$

where, t is the calculated thickness, m is an integer (e.g., 1, 2, 3, . . . ) corresponding to the order of antiresonance, λ is the operating wavelength, and n is the refractive index of the first nested capillaries 66.

In embodiments, the anti-resonant hollow core optical fiber 10 further includes a plurality of second nested capillaries 82. The plurality of second nested capillaries 82 extends longitudinally from the first fiber end 12 to the second fiber end 14. Each of the plurality of second nested capillaries 82 includes an end 84 (see FIG. 1) disposed proximate the first cladding end 24 and can at least partially define the first fiber end 12. Each of the second nested capillaries 82 includes another end 86 disposed proximate the second cladding end 26 and can at least partially define the second fiber end 14.

Each of the plurality of second nested capillaries 82 is disposed within the first nested interior 74 of a different one of the plurality of first nested capillaries 66. Each of the second nested capillaries 82 includes a second capillary axis 88. The second capillary axis 88 is parallel to the fiber longitudinal axis 16, the primary longitudinal axis 46, and the first capillary axis 68. Each of the second nested capillaries 82 includes a second nested inner surface 90 at a second nested inner radius 92 from the second capillary axis 88. The second nested inner surface 90 defines a second nested interior 94.

Each of the second nested capillaries 82 further includes a second nested outer surface 96 at a second nested outer radius 98 from the second capillary axis 88. In embodiments, the second nested outer radius 98 is greater than or equal to 10 μm, or greater than or equal to 15 μm, or greater than or equal to 20 μm, or greater than or equal to 25 μm, or greater than or equal to 30 μm, or greater than or equal to 35 μm, or greater than or equal to 40 μm, or greater than or equal to 50 μm, or greater than or equal to 60 μm, or greater than or equal to 70 μm, or less than or equal to 85 μm, or less than or equal to 75 μm, or less than or equal to 65 μm, or less than or equal to 55 μm, or less than or equal to 50 μm, or less than or equal to 45 μm, or less than or equal to 40 μm, or less than or equal to 35 μm, or in the range from 10 μm to 85 μm, or in the range from 10 μm to 80 μm, or in the range from 10 μm to 70 μm, or in the range from 10 μm to 55 μm, or in the range from 10 μm to 45 μm, or in the range from 15 μm to 40 μm, or in the range from 15 μm to 35 μm.

Each of the second nested capillaries 82 further includes a second nested thickness 100. The second nested thickness 100 is the distance measured radially from the second capillary axis 88 between the second nested inner surface 90 and the second nested outer surface 96 and is equal to the difference between the second nested outer radius 98 and the second nested inner radius 92. In embodiments, the second nested thickness 100 is within a range of from 250 nm to 1500 nm. For example, the second nested thickness 100 is 250 nm, 300 nm, 350 nm, 400 nm, 450 nm, 500 nm, 550 nm, 600 nm, 650 nm, 700 nm, 750 nm, 800 nm, 850 nm, 900 nm, 950 nm, 1000 nm, 1050 nm, 1100 nm, 1150 nm, 1200 nm, 1250 nm, 1300 nm, 1350 nm, 1400 nm, 1450 nm, 1500 nm, or within any range bound by any two of those values (e.g., from 350 nm to 700 nm, from 500 nm to 850 nm, from 1150 nm to 1400 nm, and so on). In embodiments, the second nested thickness 100 is within ±30%, ±25%, ±20%, ±15%, ±10%, or ±5% of a calculated thickness t as defined by the equation:

$$t = \frac{( 2 m - 1 ) λ}{4 \sqrt{{n}^{2} - 1}}$$

where, t is the calculated thickness, m is an integer (e.g., 1, 2, 3, . . . ) corresponding to the order of antiresonance, λ is the operating wavelength, and n is the refractive index of the second nested capillaries 82.

FIG. 2C illustrates an anti-resonant cladding element of the anti-resonant hollow core optical fiber 10 depicted in FIG. 1. As described above, the anti-resonant cladding element includes primary capillary 20, first nested capillary 66, and second nested capillary 82. Second nested capillary 82 is nested within primary capillary 20 and first nested capillary 66 and may be referred to as a doubly nested capillary to signify that it is nested within each of two other capillaries. First nested capillary 66, in contrast, is nested in only primary capillary 20 and is a singly nested capillary. In embodiments, the anti-resonant cladding elements of the anti-resonant hollow core optical fiber 10 include one or more multiply nested capillaries where a multiply nested capillary is a capillary nested in two or more other capillaries. The two or more capillaries include the primary capillary and one or more capillaries nested in the primary capillary. Preferably all anti-resonant cladding elements of the anti-resonant hollow core optical fiber include a multiply nested capillary.

By way of example, FIG. 2D shows an anti-resonant cladding element that includes a triply nested capillary. The anti-resonant cladding element includes primary capillary 2, first nested capillary 4, second nested capillary 6, and third nested capillary 8. First nested capillary 4 is a singly nested capillary. Second nested capillary 6 is a doubly nested capillary. Third nested capillary 8 is a triply nested capillary. Each capillary extends longitudinally within the cladding tube 18 from the first fiber end 12 to the second fiber end 14. Each capillary includes a capillary axis parallel to both the fiber longitudinal axis 16 and the primary longitudinal axis 46. Each capillary further includes an inner surface, an outer surface, a thickness, an inner radius, an outer radius, and an interior as described above.

The primary capillary is the largest capillary of the anti-resonant cladding element and has the dimensions (radii, thickness) given above for primary capillary 20 in the embodiment of FIG. 1. A singly nested capillary is the second largest capillary of the anti-resonant cladding element and has the dimensions (radii, thickness) given above for first nested capillary 66 in the embodiment of FIG. 1. A doubly nested capillary is the third largest capillary of the anti-resonant cladding element and has the dimensions (radii, thickness) given above for second nested capillary 82 in the embodiment of FIG. 1.

Triply and higher (quadruply, quintuply, etc.) nested capillaries have thicknesses in the ranges given above for primary capillary 20, first nested capillary 66, and second nested capillaries 82 in the embodiment of FIG. 1. The nested outer radius of triply and higher nested capillaries is smaller than the outer radius of the double nested capillary in which they are nested. In embodiments, the nested outer radius of a triply nested capillary is greater than or equal to 10 μm, or greater than or equal to 15 μm, or greater than or equal to 20 μm, or greater than or equal to 25 um, or greater than or equal to 30 μm, or greater than or equal to 35 μm, is greater than or equal to 40 μm, or greater than or equal to 45 μm, or greater than or equal to 50 μm, or greater than or equal to 55 μm, or greater than or equal to 60 μm, or greater than or equal to 65 μm, or less than or equal to 90 μm, or less than or equal to 70 μm, or less than or equal to 50 μm, or in the range from 10 μm to 80 μm, or in the range from 10 μm to 70 μm, or in the range from 10 μm to 60 μm, or in the range from 10 μm to 50 μm, or in the range from 10 μm to 45 μm, or in the range from 10 μm to 40 μm, or in the range from 10 μm to 35 μm, or in the range from 15 μm to 30 μm.

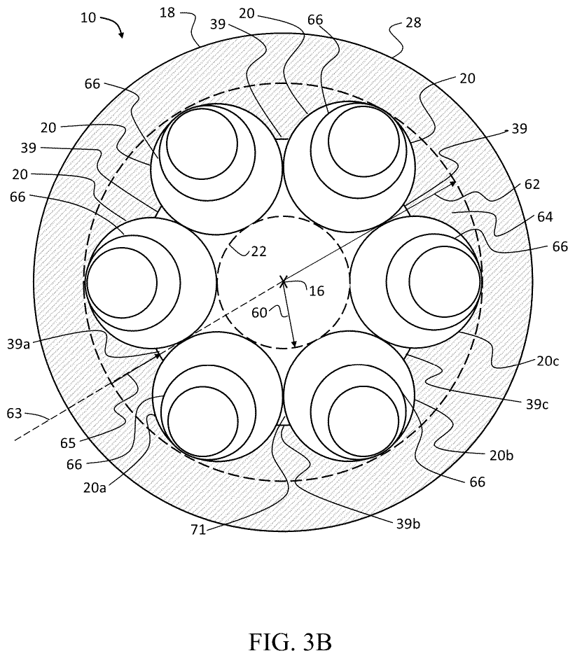

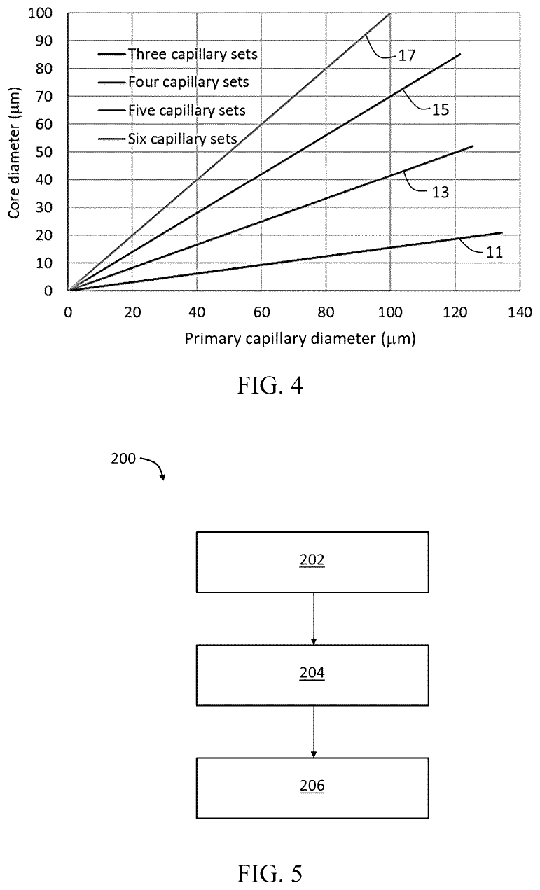

Specific dimensions of the primary capillary and nested capillaries of the anti-resonant cladding elements depend on the number of primary capillaries arranged about longitudinal axis 16 and/or the core radius of the anti-resonant hollow core optical fiber. FIG. 4, for example, shows the dependence of core diameter on the outer diameter of the primary capillary for core regions defined by sets of contacting primary capillaries that differ in the number of contacting primary capillaries. The centers of the contacting primary capillaries are equally spaced in the azimuthal direction around the longitudinal axis of the antiresonant hollow core optical fiber. In FIG. 4, trace 11 corresponds to three equally spaced primary capillaries, trace 13 corresponds to four equally spaced primary capillaries, trace 15 corresponds to five equally spaced primary capillaries, and trace 17 corresponds to six equally spaced primary capillaries. For a given diameter of the primary capillary, the core diameter increases as the number of primary capillaries in the set of primary capillaries increases.

In embodiments, the nested outer radius of a singly nested capillary is in a range from 50% to 95%, or in a range from 55% to 90%, or in a range from 60% to 85%, or in a range from 60% to 80% of the outer radius of the primary capillary in which it is nested. In embodiments, the nested outer radius of a doubly nested capillary is in a range from 50% to 95%, or in a range from 55% to 90%, or in a range from 60% to 85%, or in a range from 60% to 80% of the outer radius of the singly nested capillary in which it is nested. In embodiments, the nested outer radius of a triply nested capillary is in a range from 50% to 95%, or in a range from 55% to 90%, or in a range from 60% to 85%, or in a range from 60% to 80% of the outer radius of the doubly nested capillary in which it is nested. In embodiments, the nested outer radius of a (n+1)^{th} nested capillary is in a range from 50% to 95%, or in a range from 55% to 90%, or in a range from 60% to 85%, or in a range from 60% to 80% of the outer radius of the nth nested capillary in which it is nested.

In the embodiments depicted in FIGS. 1, 2C, and 2D, each nested capillary contacts the primary capillary at a common point corresponding to the point of contact of the primary capillary with the cladding inner surface 30 of the cladding tube 18. In other embodiments, one or more of the nested capillaries contact each other or the primary capillary at a contact point other than the point of contact of the primary capillary with the cladding inner surface 30 of the cladding tube 18. FIG. 2E illustrates embodiments of the anti-resonant cladding element of FIG. 2C in which one or more of the nested capillaries are positioned away from the point of contact of the primary capillary with the cladding inner surface 30 of the cladding tube 18. Configuration (I) corresponds to the anti-resonant cladding element of FIG. 2C and includes the location P of the point of contact of the primary capillary with the cladding inner surface 30 of the cladding tube 18. In configuration (II), first nested capillary 66 remains at the point of contact P and second nested capillary 82 is positioned away from the point of contact P and contacts first nested capillary 66 at point P1. In configuration (III), first nested capillary 66 and second nested capillary 82 maintain contact with primary capillary 20 at a common point P2, but the point P2 is displaced from the point of contact P. In configuration (IV), second nested capillary 82 contacts first nested capillary 66 at point P4 and first nested capillary 66 contacts primary capillary 20 at point P3, where neither P3 nor P4 coincides with point P. In embodiments, a nested capillary is positioned at a contact point with the inner surface of the capillary in which it is nested at any angular position. FIG. 2F shows examples of alternate positions of the nested capillaries of the anti-resonant cladding element of FIG. 2D relative to the point of contact of the primary capillary with the cladding inner surface 30 of the cladding tube 18.

The dimensions of the primary and nested capillaries are designed to minimize confinement loss of the fundamental mode and to suppress higher order modes of electromagnetic radiation 23 propagating in anti-resonant hollow core optical fiber 10. The greater the confinement loss of higher order modes, the better the signal quality of the fundamental mode.

In embodiments, the anti-resonant hollow core optical fiber 10 exhibits a confinement loss for the fundamental mode of electromagnetic radiation 23, throughout an entirety of a wavelength range of from 1500 nm to 1600 nm, that is less than or equal to 0.50 dB/km. For example, the confinement loss that the anti-resonant hollow core optical fiber 10 exhibits for the fundamental mode of electromagnetic radiation 23 at each wavelength in the wavelength range from 1500 nm to 1600 nm is less than or equal to 0.50 dB/km, or less than or equal to 0.40 dB/km, or less than or equal to 0.30 dB/km, or less than or equal to 0.20 dB/km, or less than or equal to 0.15 dB/km, or less than or equal to 0.10 dB/km, or less than or equal to 0.05 dB/km, or in a range from 0.01 dB/km to 0.50 dB/km, or in a range from 0.01 dB/km to 0.40 dB/km, or in a range from 0.01 dB/km to 0.30 dB/km, or in a range from 0.01 dB/km to 0.20 dB/km, or in a range from 0.01 dB/km to 0.10 dB/km, or in a range from 0.03 dB/km to 0.50 dB/km, or in a range from 0.03 dB/km to 0.40 dB/km, or in a range from 0.03 dB/km to 0.30 dB/km, or in a range from 0.03 dB/km to 0.20 dB/km, or in a range from 0.03 dB/km to 0.10 dB/km, or in a range from 0.05 dB/km to 0.50 dB/km, or in a range from 0.05 dB/km to 0.40 dB/km, or in a range from 0.05 dB/km to 0.30 dB/km, or in a range from 0.05 dB/km to 0.20 dB/km, or in a range from 0.05 dB/km to 0.10 dB/km.

In other embodiments, the confinement loss that the anti-resonant hollow core optical fiber 10 exhibits for the fundamental mode of electromagnetic radiation 23 at each wavelength in the wavelength range from 1300 nm to 1600 nm is less than or equal to 0.50 dB/km, or less than or equal to 0.40 dB/km, or less than or equal to 0.30 dB/km, or less than or equal to 0.20 dB/km, or less than or equal to 0.15 dB/km, or less than or equal to 0.10 dB/km, or less than or equal to 0.05 dB/km, or in a range from 0.01 dB/km to 0.50 dB/km, or in a range from 0.01 dB/km to 0.40 dB/km, or in a range from 0.01 dB/km to 0.30 dB/km, or in a range from 0.01 dB/km to 0.20 dB/km, or in a range from 0.01 dB/km to 0.10 dB/km, or in a range from 0.03 dB/km to 0.50 dB/km, or in a range from 0.03 dB/km to 0.40 dB/km, or in a range from 0.03 dB/km to 0.30 dB/km, or in a range from 0.03 dB/km to 0.20 dB/km, or in a range from 0.03 dB/km to 0.10 dB/km, or in a range from 0.05 dB/km to 0.50 dB/km, or in a range from 0.05 dB/km to 0.40 dB/km, or in a range from 0.05 dB/km to 0.30 dB/km, or in a range from 0.05 dB/km to 0.20 dB/km, or in a range from 0.05 dB/km to 0.10 dB/km.

In further embodiments, the confinement loss that the anti-resonant hollow core optical fiber 10 exhibits for the fundamental mode of electromagnetic radiation 23 at each wavelength in the wavelength range from 1300 nm to 1400 nm is less than or equal to 0.50 dB/km, or less than or equal to 0.40 dB/km, or less than or equal to 0.30 dB/km, or less than or equal to 0.20 dB/km, or less than or equal to 0.15 dB/km, or less than or equal to 0.10 dB/km, or less than or equal to 0.05 dB/km, or in a range from 0.01 dB/km to 0.50 dB/km, or in a range from 0.01 dB/km to 0.40 dB/km, or in a range from 0.01 dB/km to 0.30 dB/km, or in a range from 0.01 dB/km to 0.20 dB/km, or in a range from 0.01 dB/km to 0.10 dB/km, or in a range from 0.03 dB/km to 0.50 dB/km, or in a range from 0.03 dB/km to 0.40 dB/km, or in a range from 0.03 dB/km to 0.30 dB/km, or in a range from 0.03 dB/km to 0.20 dB/km, or in a range from 0.03 dB/km to 0.10 dB/km, or in a range from 0.05 dB/km to 0.50 dB/km, or in a range from 0.05 dB/km to 0.40 dB/km, or in a range from 0.05 dB/km to 0.30 dB/km, or in a range from 0.05 dB/km to 0.20 dB/km, or in a range from 0.05 dB/km to 0.10 dB/km.

In embodiments, the anti-resonant hollow core optical fiber 10 exhibits a confinement loss for the higher order modes of electromagnetic radiation 23, throughout an entirety of a wavelength range of from 1500 nm to 1600 nm, that is greater than or equal to 0.50 dB/km. For example, the confinement loss that the anti-resonant hollow core optical fiber 10 exhibits for the higher order modes of electromagnetic radiation 23 at each wavelength in the wavelength range from 1500 nm to 1600 nm is greater than or equal to 0.50 dB/km, or greater than or equal to 1.0 dB/km, or greater than or equal to 5.0 dB/km, or greater than or equal to 10 dB/km, or greater than or equal to 25 dB/km, or greater than or equal to 50 dB/km, or greater than or equal to 100 dB/km, or greater than or equal to 500 dB/km, or greater than or equal to 1000 dB/km, or in a range from 0.50 dB/km to 10000 dB/km, or in a range from 0.50 dB/km to 5000 dB/km, or in a range from 0.50 dB/km to 1000 dB/km, or in a range from 1.0 dB/km to 500 dB/km, or in a range from 5.0 dB/km to 250 dB/km, or in a range from 7.5 dB/km to 200 dB/km, or in a range from 10 dB/km to 150 dB/km.

In embodiments, the anti-resonant hollow core optical fiber 10 exhibits a confinement loss for the higher order modes of electromagnetic radiation 23, throughout an entirety of a wavelength range of from 1300 nm to 1600 nm, that is greater than or equal to 0.50 dB/km. For example, the confinement loss that the anti-resonant hollow core optical fiber 10 exhibits for the higher order modes of electromagnetic radiation 23 at each wavelength in the wavelength range from 1500 nm to 1600 nm is greater than or equal to 0.50 dB/km, or greater than or equal to 1.0 dB/km, or greater than or equal to 5.0 dB/km, or greater than or equal to 10 dB/km, or greater than or equal to 25 dB/km, or greater than or equal to 50 dB/km, or greater than or equal to 100 dB/km, or greater than or equal to 500 dB/km, or greater than or equal to 1000 dB/km, or in a range from 0.50 dB/km to 1000 dB/km, or in a range from 1.0 dB/km to 500 dB/km, or in a range from 5.0 dB/km to 250 dB/km, or in a range from 7.5 dB/km to 200 dB/km, or in a range from 10 dB/km to 150 dB/km.

In embodiments, the anti-resonant hollow core optical fiber 10 exhibits a confinement loss for the higher order modes of electromagnetic radiation 23, throughout an entirety of a wavelength range of from 1300 nm to 1400 nm, that is greater than or equal to 0.50 dB/km. For example, the confinement loss that the anti-resonant hollow core optical fiber 10 exhibits for the higher order modes of electromagnetic radiation 23 at each wavelength in the wavelength range from 1500 nm to 1600 nm is greater than or equal to 0.50 dB/km, or greater than or equal to 1.0 dB/km, or greater than or equal to 5.0 dB/km, or greater than or equal to 10 dB/km, or greater than or equal to 25 dB/km, or greater than or equal to 50 dB/km, or greater than or equal to 100 dB/km, or greater than or equal to 500 dB/km, or greater than or equal to 1000 dB/km, or in a range from 0.50 dB/km to 1000 dB/km, or in a range from 1.0 dB/km to 500 dB/km, or in a range from 5.0 dB/km to 250 dB/km, or in a range from 7.5 dB/km to 200 dB/km, or in a range from 10 dB/km to 150 dB/km.

Referring now to FIGS. 5-9, a method 200 of manufacturing the anti-resonant hollow core optical fiber 10 is described herein. The method 200 includes at least a preform recess formation step 202, a primary preform capillary arrangement step 204, and a drawing step 206.

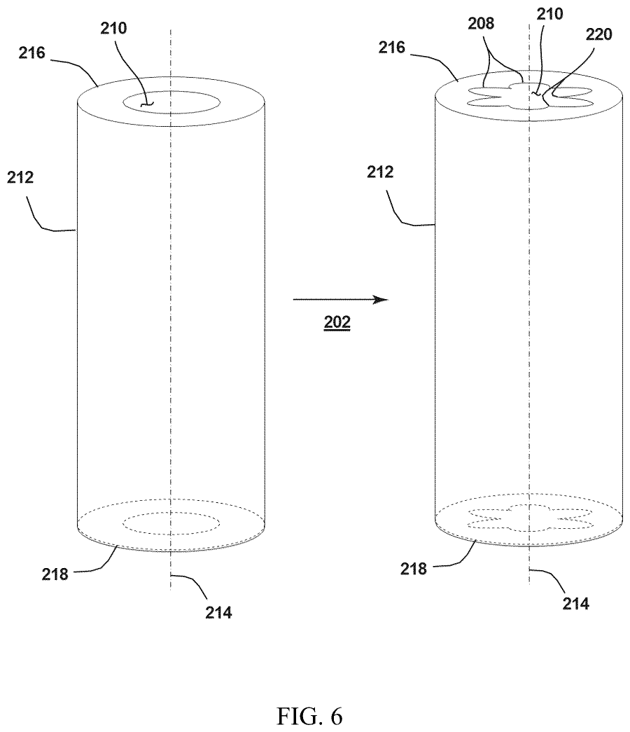

The preform recess formation step 202 (see FIG. 6) includes forming a plurality of preform recesses 208 within a cladding preform inner surface 210 of a cladding preform tube 212 through which a cladding preform longitudinal axis 214 extends. For example, the cladding preform inner surface 210 can initially be cylindrical. The plurality of recesses 208 can then be machined into the cladding preform inner surface 210. Each of the plurality of preform recesses 208 is disposed longitudinally from a first preform end 216 to a second preform end 218 of the cladding preform tube 212. In embodiments, each of the plurality of perform recesses 208 merges with an adjacent preform recess 208 in both azimuthal directions around the preform longitudinal axis so that the cladding preform inner surface 210 forms preform peaks 220 pointing inward toward the cladding preform longitudinal axis 214. In other embodiments, the cladding preform inner surface 201 forms plateaus (not separately illustrated) of constant radius from the cladding preform longitudinal axis 214 between adjacent preform recesses 208 in both azimuthal directions around the preform longitudinal axis 214.

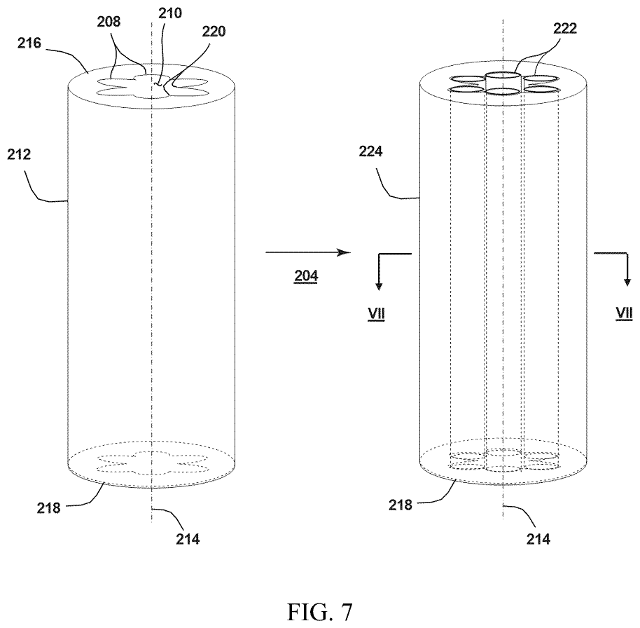

The primary preform capillary arrangement step 204 (see FIGS. 7-8) includes arranging a plurality of primary preform capillaries 222 within the plurality of preform recesses 208 of the cladding preform tube 212. For example, the plurality of primary preform capillaries 222 can be formed and fused (e.g., via flame treatment, laser treatment, among other ways) to the cladding preform inner surface 210 with the plurality of preform recesses 208. The coupling of the plurality of primary preform capillaries 222 to the cladding preform tube 212 forms an optical fiber preform 224. Nested preform capillaries (not separately illustrated) can be similarly formed and fused to the inner surface of the primary preform capillaries 222 either before or after coupling of the plurality of primary preform capillaries 222 to the cladding preform tube 212. Each of the plurality of primary preform capillaries 222 includes an outer primary preform surface 224 at an outer primary preform radius 226 from a primary capillary preform axis 228. The primary capillary preform axis 228 is parallel to the cladding preform longitudinal axis 214. Each of the plurality of primary preform capillaries 222 contacts an adjacent primary preform capillary 222 in both azimuthal directions around the cladding preform longitudinal axis 214. Each of the plurality of primary preform capillaries 222 contacts the cladding preform inner surface 210. The plurality of preform recesses 208 is dimensioned to substantially match the outer primary preform radius 226 of the plurality of primary preform capillaries 222.

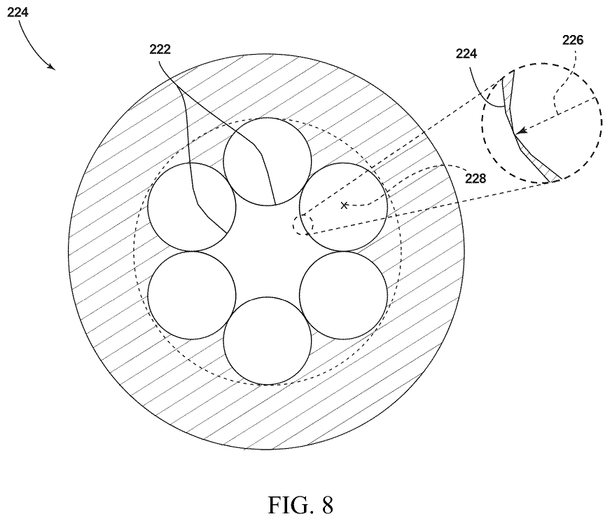

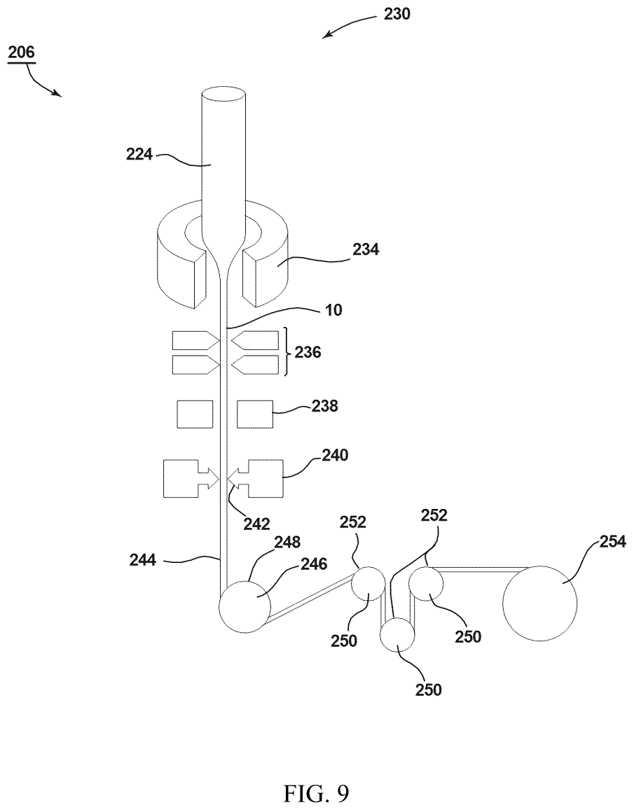

The drawing step 206 includes drawing the anti-resonant hollow core optical fiber 10 from the optical fiber preform 224. The drawing step 206 (see FIG. 9) can be performed using a draw system 230. The draw system 230 can include a furnace for heating the optical fiber preform 224 to melt or soften the cladding preform tube 212 and the plurality of primary preform capillaries 222. The furnace 232 can be disposed in a draw tower. In embodiments, the furnace 232 includes a heater 234 such that the optical fiber preform 224 is consumed and drawn into the anti-resonant hollow core optical fiber 10 as it is lowered towards the heater 234. The draw system 230 can further include non-contact measurement sensors 236 for measuring the size (e.g., cladding outer radius 32) of the anti-resonant hollow core optical fiber 10 that exits the furnace 232. A cooling station 238 can reside downstream of the measurement sensors 236 and is configured to cool the anti-resonant hollow core optical fiber 10. A coating station 240 can reside downstream of the cooling station 238. The coating station 240 is configured to deposit a protective coating material 242 onto the anti-resonant hollow core optical fiber 10 to form a coated anti-resonant hollow core optical fiber 244. A tensioner 246 resides downstream of the coating station 240. The tensioner 246 has a surface 248 that pulls (draws) the coated anti-resonant hollow core optical fiber 244. A set of guide wheels 250 with respective surfaces 252 resides downstream of the tensioner 246. The guide wheels 250 serve to guide the coated anti-resonant hollow core optical fiber 244 to a fiber take-up spool 254 to store the coated anti-resonant hollow core optical fiber 244.

The cladding tube 18, the plurality of primary capillaries 20, the plurality of first nested capillaries 66, the plurality of second nested capillaries 82, and further nested capillaries of the anti-resonant hollow core optical fiber 10 can all be made of or include silica. The silica of any of the cladding tube 18, the plurality of primary capillaries 20, the plurality of first nested capillaries 66, the plurality of second nested capillaries 82, and further nested capillaries can be doped with a viscosity-altering dopant (e.g., nitrogen, fluorine, alkali metals, alkaline earth metals, among other options) as desired to set conditions (e.g., melting point) to facilitate manufacturing (e.g., draw).

The anti-resonant hollow core optical fiber 10 and the method 200 of the present disclosure address the problems described in the Background, among others, in a variety of ways. For example, the anti-resonant hollow core optical fiber 10 exhibits relatively low confinement loss for the fundamental mode of the electromagnetic radiation 23 within and throughout the wavelength range from 1500 nm to 1600 nm, or the wavelength range from 1300 nm to 1600 nm, or the wavelength range from 1300 nm to 1400 nm. The low confinement loss within such wavelength ranges is desirable because 1310 nm and 1550 nm are common target operating wavelengths. The low confinement loss was surprising because the merging or contacting of the plurality of primary capillaries 20 constitutes nodes, which are generally understood in the prior art to increase confinement loss. Without wishing to be bound by theory, it is theorized that the presence of nodes induces coupling between the core mode and the dielectric modes within the primary capillaries 20, which themselves leak into the cladding tube 18. The designs described herein of the anti-resonant hollow core optical fiber 10 reduce that theorized phenomena by burying the leakage loss from the dielectric modes associated with the primary capillaries 20 within the cladding tube 18 via the plurality of recesses 38. However, the confinement loss of the fundamental mode through the joints of primary capillaries and the cladding of the anti-resonant hollow core optical fiber 10 can be reduced though proper designs of multiply nested capillaries. In addition, the multiply nested capillarity designs offer flexibility in increasing the confinement loss for the higher order modes, which is beneficial for achieving single mode operations in an antiresonant hollow core optical fiber.

As mentioned above, manufacture of the anti-resonant hollow core optical fiber 10 is difficult and variances in relative positioning of the primary capillaries 20 and nested capillaries can occur. Especially, two primary capillaries can contact each other forming a node, which would normally cause upward spikes in confinement loss for the fundamental mode as a function of wavelength. Such spikes, however, are not observed for the anti-resonant hollow core optical fibers 10 disclosed herein.

Further and related, the design intention that adjacent primary capillaries 20 contact or merge eases manufacturing. Typically, the anti-resonance depends on adjacent primary capillaries 20 not contacting or merging, with an air gap separating them. However, this is difficult to achieve in practice, because as the preform enters the draw furnace 232, gas pressure within the primary capillaries 20 increases, which causes the primary capillaries 20 to expand, which can result in them contacting each other, before the gas pressure decreases and the primary capillaries 20 deflate. That is no longer an issue because adjacent primary capillaries 20 of the anti-resonant hollow core optical fiber 10 are designed to contact or merge.

Moreover, typically, the anti-resonance depends on the plurality of primary capillaries 20 maintaining a precise angle of attachment to the cladding inner surface 30. Manufacture can result in angular variations or rotations along the length of the optical fiber. However, with the plurality of recesses 38 cradling the plurality of primary capillaries 20, angular variation and rotation is much less likely to occur during the drawing step 206.

### EXAMPLES

Representative examples of anti-resonant hollow core optical fibers are now described. Various exemplary fiber designs that differed in the number and/or dimensions of primary and/or nested capillaries included in the anti-resonant cladding elements. In each design, (a) the anti-resonant cladding elements were equally spaced in the azimuthal direction about the longitudinal axis of the anti-resonant hollow core optical fiber, (b) each primary capillary was in contact with an adjacent primary capillary in each azimuthal direction (clockwise and counterclockwise) about the longitudinal axis of the anti-resonant hollow core optical fiber, (c) all nested capillaries were in contact along a common radial line extending from the center of the hollow core to the point of contact of the primary capillary with the inside surface of the cladding tube, and (d) the cladding tube occupied an entirety of the primary capillary region, outside of the primary capillaries, that was radially inward of the capillary region radius and radially outward of where adjacent primary capillaries contacted or merged. The confinement loss of the fundamental mode and higher order modes as a function of wavelength of electromagnetic radiation transmitted in the core region of each exemplary design was modeled using COMSOL Multiphysics® finite element software.

### Example 1

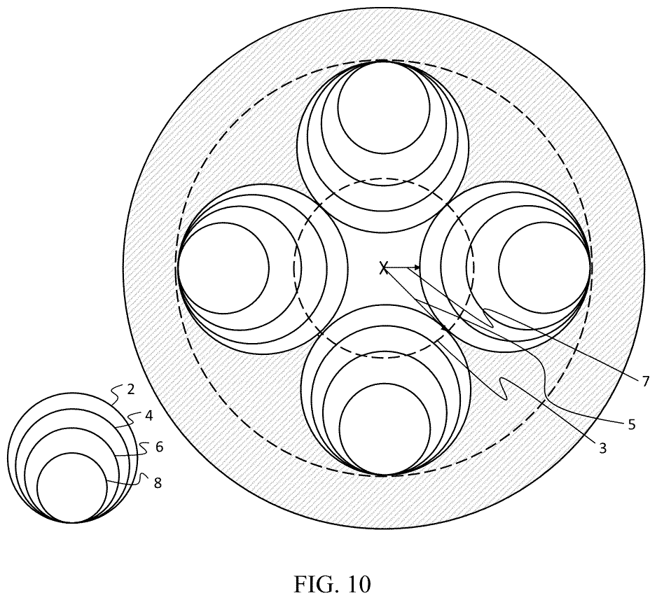

In this example, the anti-resonant hollow core optical fiber has the design shown in FIG. 10. The design includes four anti-resonant cladding elements of the type shown in FIG. 2D, which is reproduced in FIG. 10. Each anti-resonant cladding element included a primary capillary 2, a first nested capillary 4, a second nested capillary 6, and a third nested capillary 8. FIG. 10 also shows a circle 3 that intersects the points of contact of the primary capillaries 2. The radius 5 of circle 3 is referred to as a “contact radius” and represents the distance between the center of the core region and the points of contact of the primary capillaries 2. Also shown is core radius 7.

The dimensions of corresponding capillaries were the same for the four anti-resonant cladding elements and are given in Table 1. The thickness of all capillaries was 500 nm.

TABLE 1

Core radius = 15.0 μm
Contact radius = 37.4 μm
Outer radius of primary capillary = 36.2 μm
Outer radius of first nested capillary = 34.0 μm
Outer radius of second nested capillary = 29.0 μm
Outer radius of third nested capillary = 24.0 μm
Capillary thickness = 500 nm

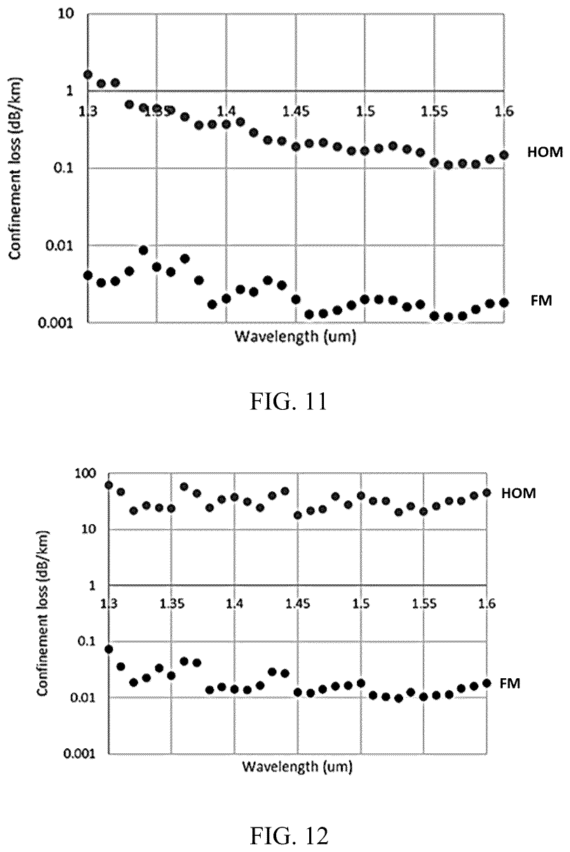

FIG. 11 shows the confinement loss as a function of wavelength of electromagnetic radiation over the wavelength range from 1300 nm to 1600 nm (1.3 μm to 1.6 μm) for the fundamental mode (FM) and higher order modes (HOM) of the design of Example 1. The confinement loss of the fundamental mode (FM) was less than 0.01 dB/km at each wavelength in the wavelength range from 1300 nm to 1600 nm and less than 0.005 dB/km at each wavelength in the wavelength range from 1400 nm to 1600 nm. The confinement loss of higher order modes (HOM) was between 0.1 dB/km and 2 dB/km at each wavelength in the wavelength range from 1300 nm to 1600 nm. Although the confinement loss of higher order modes (HOM) is greater than the confinement loss of the fundamental mode (FM), it is still relatively low and suggests likely suitability of the design of Example 1 for multimode operation.

### Example 2

In this example, the design of Example 1 was modified to increase the confinement loss of higher order modes (HOM) to improve suitability of the fiber for single mode operation. The confinement loss was increased by decreasing the radii of the second and third nested capillaries to provide better matching of the effective index of the anti-resonant cladding element and the effective index of higher order modes (HOM) to increase coupling of the higher order modes (HOM) to the cladding. All other dimensions were maintained as described in Example 1.

TABLE 2

Core radius = 15.0 μm
Contact radius = 37.4 μm
Outer radius of primary capillary = 36.2 μm
Outer radius of first nested capillary = 34.0 μm
Outer radius of second nested capillary = 26.0 μm
Outer radius of third nested capillary = 16.0 μm
Capillary thickness = 500 nm

FIG. 12 shows the confinement loss as a function of wavelength of electromagnetic radiation over the wavelength range from 1300 nm to 1600 nm (1.3 μm to 1.6 μm) for the fundamental mode (FM) and higher order modes (HOM) of the design of Example 2. The confinement loss of the fundamental mode (FM) was less than 0.1 dB/km at each wavelength in the wavelength range from 1300 nm to 1600 nm and less than 0.05 dB/km at each wavelength in the wavelength range from 1400 nm to 1600 nm. The confinement loss of higher order modes (HOM) was significantly increased relative to Example 1 and was greater than 20 dB/km at each wavelength in the wavelength range from 1300 nm to 1600 nm. The high confinement loss of higher order modes (HOM) suggests suitability of the design of Example 2 for single mode operation.

### Example 3

In this example, the antiresonant hollow core optical fiber design included antiresonant cladding elements of the type shown in FIG. 2D and described in Examples 1 and 2 above. Instead of four antiresonant cladding elements, however, the design included five antiresonant cladding elements that were equally spaced in the azimuthal direction. The dimensions of each of the five antiresonant cladding elements was the same and the thickness of all capillaries was 500 nm. Relevant dimensions are given in Table 3.

TABLE 3

Core radius = 17.5 μm
Contact radius = 37.5 μm
Outer radius of primary capillary = 25.0 μm
Outer radius of first nested capillary = 23.0 μm
Outer radius of second nested capillary = 14.0 μm
Outer radius of third nested capillary = 10.0 μm
Capillary thickness = 500 nm

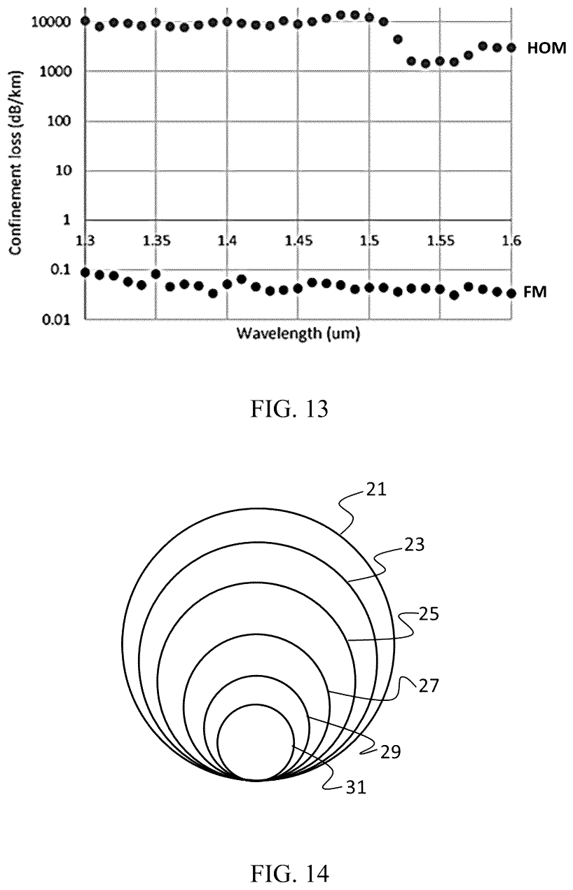

FIG. 13 shows the confinement loss as a function of wavelength of electromagnetic radiation over the wavelength range from 1300 nm to 1600 nm (1.3 μm to 1.6 μm) for the fundamental mode (FM) and higher order modes (HOM) of the design of Example 3. The confinement loss of the fundamental mode (FM) was less than 0.1 dB/km at each wavelength in the wavelength range from 1300 nm to 1600 nm. The confinement loss of higher order modes (HOM) was significantly increased relative to Example 1 and Example 2, and was greater than 1000 dB/km at each wavelength in the wavelength range from 1300 nm to 1600 nm. The high confinement loss of higher order modes (HOM) suggests suitability of the design of Example 3 for single mode operation.

### Example 4

In this example, the design shown in FIG. 10 for Example 1 was modified to include additional nested capillaries. In particular, the antiresonant cladding elements included a primary capillary that contained five nested capillaries as shown in FIG. 14. Each anti-resonant cladding element included a primary capillary 21, a first nested capillary 23, a second nested capillary 25, a third nested capillary 27, a fourth nested capillary 29, and a fifth nested capillary 31. Four of the anti-resonant cladding elements were included in the design. The dimensions of each of the four antiresonant cladding elements was the same and are given in Table 4. The thickness of all capillaries was 470 nm.

TABLE 4

Core radius = 10 μm
Contact radius = 37.5 μm
Outer radius of primary capillary = 24.1 μm
Outer radius of first nested capillary = 22.3 μm
Outer radius of second nested capillary = 17.9 μm
Outer radius of third nested capillary = 14.2 μm
Outer radius of fourth nested capillary = 10.5 μm
Outer radius of fifth nested capillary = 7.2 μm
Capillary thickness = 470 nm

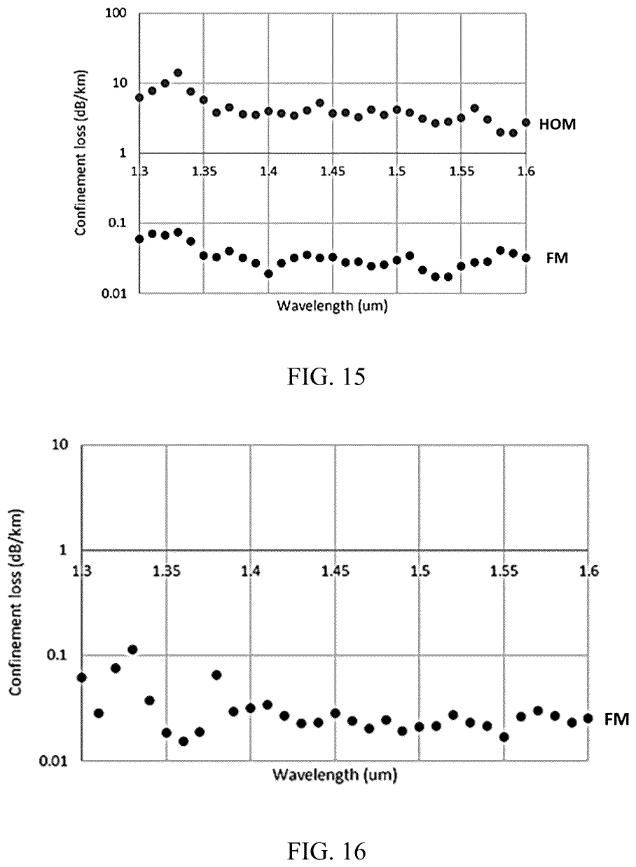

FIG. 15 shows the confinement loss as a function of wavelength of electromagnetic radiation over the wavelength range from 1300 nm to 1600 nm (1.3 μm to 1.6 μm) for the fundamental mode (FM) and higher order modes (HOM) of the design of Example 4. The confinement loss of the fundamental mode (FM) was less than 0.1 dB/km at each wavelength in the wavelength range from 1300 nm to 1600 nm and was less than 0.05 dB/km at each wavelength in the wavelength range from 1350 nm to 1600 nm. The confinement loss of higher order modes (HOM) was between 2 dB/km and 15 dB/km at each wavelength in the wavelength range from 1300 nm to 1600 nm.

### Example 5

In this example, three antiresonant cladding elements were used in the fiber design. Each antiresonant cladding element included six nested capillaries and corresponded to a modification of the antiresonant cladding element shown in FIG. 14 to include one additional nested capillary. The dimensions of each of the four antiresonant cladding elements was the same and are given in Table 4. The thickness of all capillaries was 450 nm.

TABLE 5

Core radius = 7.5 μm
Contact radius = 26.3 μm
Outer radius of primary capillary = 48.4 μm
Outer radius of first nested capillary = 45.0 μm
Outer radius of second nested capillary = 40.9 μm
Outer radius of third nested capillary = 35.4 μm
Outer radius of fourth nested capillary = 29.9 μm
Outer radius of fifth nested capillary = 24.4 μm
Outer radius of sixth nested capillary = 19.8 μm
Capillary thickness = 450 nm

FIG. 16 shows the confinement loss as a function of wavelength of electromagnetic radiation over the wavelength range from 1300 nm to 1600 nm (1.3 μm to 1.6 μm) for the fundamental mode (FM) of the design of Example 5. The confinement loss of the fundamental mode (FM) was less than 0.11 dB/km at each wavelength in the wavelength range from 1300 nm to 1600 nm and was less than 0.04 dB/km at each wavelength in the wavelength range from 1400 nm to 1600 nm. The confinement loss of higher order modes (HOM) (not shown) was greater than 1000 dB/km at each wavelength in the wavelength range from 1300 nm to 1600 nm. The high confinement loss of higher order modes (HOM) suggests suitability of the fiber of Example 5 for single mode operation.

It will be apparent to those skilled in the art that various modifications and variations can be made without departing from the spirit or scope of the claims.

What is claimed is:

1. An anti-resonant hollow core optical fiber comprising:
a fiber longitudinal axis extending from a first fiber end to a second fiber end;
a cladding tube extending from the first fiber end to the second fiber end azimuthally around the fiber longitudinal axis, the cladding tube comprising (a) a cladding outer surface at a cladding outer radius from the fiber longitudinal axis and (b) a cladding inner surface at a cladding inner radius from the fiber longitudinal axis, wherein the cladding inner radius is azimuthally variable around the fiber longitudinal axis and the cladding inner surface defines a plurality of recesses;
a plurality of primary capillaries arranged azimuthally around the fiber longitudinal axis, each of the plurality of primary capillaries (a) disposed within a different one of the plurality of recesses and contacting the cladding inner surface, (b) contacting or merging with an adjacent primary capillary in both azimuthal directions around the fiber longitudinal axis, and (c) comprising (i) a primary longitudinal axis that is parallel to the fiber longitudinal axis, (ii) a primary outer surface at a primary outer radius from the primary longitudinal axis, and (iii) a primary inner surface at a primary inner radius from the primary longitudinal axis, the primary inner surface defining a primary interior;
a plurality of first nested capillaries extending longitudinally from the first fiber end to the second fiber end, each of the plurality of first nested capillaries (a) disposed within the primary interior of a different one of the plurality of primary capillaries and (b) comprising (i) a first capillary axis that is parallel to the fiber longitudinal axis and (ii) a first nested interior;
a plurality of second nested capillaries extending longitudinally from the first fiber end to the second fiber end, each of the plurality of second nested capillaries (a) disposed within the first nested interior of a different one of the plurality of first nested capillaries and (b) comprising (i) a second capillary axis that is parallel to the fiber longitudinal axis and (ii) a second nested interior; and
an effective core region tangential to the plurality of primary capillaries at a core radius from the fiber longitudinal axis, the plurality of primary capillaries disposed radially outward of the effective core region.

2. The anti-resonant hollow core optical fiber of claim 1, wherein
each of the plurality of recesses merges with an adjacent recess in both azimuthal directions around the fiber longitudinal axis so that the cladding inner surface forms peaks pointing inward toward the fiber longitudinal axis.

3. The anti-resonant hollow core optical fiber of claim 1, wherein
the cladding inner surface further defines plateaus where the cladding inner radius is constant azimuthally around the fiber longitudinal axis, and
each of the plurality of recesses are separated from an adjacent recess in both azimuthal directions around the fiber longitudinal axis by a different one of the plateaus.

4. The anti-resonant hollow core optical fiber of claim 1, wherein
the primary outer radius of each of the plurality of primary capillaries is within a range of from 20 μm to 90 μm.

5. The anti-resonant hollow core optical fiber of claim 1, wherein
each of the plurality of primary capillaries further comprises a primary thickness that is within a range of from 250 nm to 1500 nm.

6. The anti-resonant hollow core optical fiber of claim 1, wherein
the cladding tube has from 3 to 9 recesses,
the anti-resonant hollow core optical fiber has from 3 to 9 primary capillaries, and the quantity of recesses and the quantity of primary capillaries are the same.

7. The anti-resonant hollow core optical fiber of claim 1, wherein the core radius is within a range of from 5 μm to 100 μm.

8. The anti-resonant hollow core optical fiber of claim 1 further comprising:
a capillary region radius that is tangential to the primary outer surface of each of the plurality of primary capillaries but radially outward of the core radius; and
a primary capillary region between the capillary region radius and the core radius, each of the plurality of primary capillaries disposed entirely within the primary capillary region.
wherein the cladding tube occupies an entirety of a volume, outside of the plurality of primary capillaries, that is radially inward of the capillary region radius and radially outward of where adjacent primary capillaries contact or merge.

9. The anti-resonant hollow core optical fiber of claim 8, wherein
bury radial lines extend from the longitudinal axis radially outward through the cladding tube, each of the bury radial lines extending through where different pairs of adjacent primary capillaries contact or merge, and
the cladding tube occupies a portion of a volume, outside of the plurality of primary capillaries that is radially inward of the capillary region radius to a depth from the capillary region radius along each of the bury radial longs toward where the adjacent primary capillaries contact or merge.

10. The anti-resonant hollow core optical fiber of claim 9, wherein
the depth is from 10% to 85% of a radial distance from the capillary region radius to where the adjacent primary capillaries contact or merge.

11. The anti-resonant hollow core optical fiber of claim 1, wherein
each of the plurality of first nested capillaries further comprises a first nested outer radius from the first capillary axis that is within a range of from 15 μm to 89 μm.

12. The anti-resonant hollow core optical fiber of claim 1, wherein
the difference between the primary capillary radius and the first nested capillary radius is less than 5 μm.

13. The anti-resonant hollow core optical fiber of claim 1, wherein
each of the plurality of first nested capillaries further comprises a first nested thickness that is within a range of from 250 nm to 1500 nm.

14. The anti-resonant hollow core optical fiber of claim 1, wherein
each of the plurality of second nested capillaries further comprises a second nested outer radius from the second capillary axis that is within a range of from 10 μm to 85 μm.

15. The anti-resonant hollow core optical fiber of claim 1, wherein each of the plurality of second nested capillaries further comprises a second nested thickness that is within a range of from 250 nm to 1500 nm.

16. The anti-resonant hollow core optical fiber of claim 1 further comprising:
a plurality of third nested capillaries extending longitudinally from the first fiber end to the second fiber end, each of the plurality of third nested capillaries (a) disposed within the second nested interior of a different one of the plurality of second nested capillaries and (b) comprising (i) a third capillary axis that is parallel to the fiber longitudinal axis and (ii) a third nested interior.

17. The anti-resonant hollow core optical fiber of claim 1, wherein
the anti-resonant hollow core optical fiber exhibits a confinement loss for the fundamental mode of electromagnetic radiation at each wavelength in a wavelength range from 1300 nm to 1600 nm that is less than or equal to 0.50 dB/km.

18. The anti-resonant hollow core optical fiber of claim 1, wherein
the anti-resonant hollow core optical fiber exhibits a confinement loss for higher order modes of electromagnetic radiation at each wavelength in a wavelength range from 1300 nm to 1600 nm that is greater than or equal to 0.50 dB/km.

19. A method of manufacturing a preform for an anti-resonant hollow core optical fiber comprising:
a preform recess formation step comprising forming a plurality of preform recesses into a cladding preform inner surface of a cladding preform tube through which a cladding preform longitudinal axis extends, each of the plurality of preform recesses disposed longitudinally from a first preform end to a second preform end of the cladding preform tube;
a primary preform capillary arrangement step comprising arranging a plurality of primary preform capillaries within the plurality of preform recesses of the cladding preform tube, each of the plurality of primary preform capillaries (i) comprising an outer primary preform surface at an outer primary preform radius from a primary capillary preform axis parallel to the cladding preform longitudinal axis, (ii) contacting an adjacent primary preform capillary in both azimuthal directions around the cladding preform longitudinal axis, and (iii) contacting the cladding preform inner surface, wherein, the plurality of preform recesses is dimensioned to substantially match the outer primary preform radius of the plurality of primary preform capillaries;
a first nested preform capillary arrangement step comprising arranging a plurality of first nested preform capillaries in the plurality of primary preform capillaries, each of the plurality of primary preform capillaries including one of the plurality of first nested preform capillaries; and
a second nested preform capillary arrangement step comprising arranging a plurality of second nested preform capillaries in the plurality of first nested preform capillaries, each of the plurality of first nested preform capillaries including one of the plurality of second nested preform capillaries.

20. The method of claim 19, further comprising
a drawing step comprising drawing an anti-resonant hollow core optical fiber from the preform.
